(19) United States
(12) Patent Application Publication
(10) Pub. No.: US 2026/0020025 A1
(43) Pub. Date: Jan. 15, 2026

(54) DUAL TRANSMISSION OF UPLINK CONTROL IN A COMPONENT CARRIER GROUP

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Jing JIANG, San Diego, CA (US)

(21) Appl. No.: 18/771,360

(22) Filed: Jul. 12, 2024

(51) Int. Cl. H04W 72/21; H04B 7/06; H04L 1/1812; H04W 72/12

(52) U.S. Cl. CPC H04W 72/21; H04B 7/0626; H04L 1/1812; H04W 72/12

(57) ABSTRACT

Methods, systems, and devices for wireless communications are described. A user equipment (UE) may receive signaling indicating a configuration for communications via a first cell group and a second cell group, the first cell group comprising a first cell used for transmission of uplink control information (UCI) associated with the first cell group and the second cell group comprising a second cell used for transmission of UCI associated with the second cell group. The UE may transmit UCI associated with the second cell group to the first cell in the first cell group, to the second cell in the second cell group, or to both the first cell and the second cell, wherein transmitting the UCI associated with the second cell group to the first cell, to the second cell, or to both the first cell and the second cell is in accordance with a parameter associated with the UCI.

### FIELD OF TECHNOLOGY

The following relates to wireless communications, including dual transmission of uplink control in a component carrier group.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving signaling indicating a configuration for communications via a first cell group and a second cell group, the first cell group including a first cell used for transmission of uplink control information (UCI) associated with the first cell group and the second cell group including a second cell used for transmission of UCI associated with the second cell group and transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

A UE for wireless communications is described. The UE may include one or more memories storing processor executable code, and one or more processors coupled with the one or more memories. The one or more processors may individually or collectively be operable to execute the code to cause the UE to receive signaling indicating a configuration for communications via a first cell group and a second cell group, the first cell group including a first cell used for transmission of UCI associated with the first cell group and the second cell group including a second cell used for transmission of UCI associated with the second cell group and transmit UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

Another UE for wireless communications is described. The UE may include means for receiving signaling indicating a configuration for communications via a first cell group and a second cell group, the first cell group including a first cell used for transmission of UCI associated with the first cell group and the second cell group including a second cell used for transmission of UCI associated with the second cell group and means for transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

A non-transitory computer-readable medium storing code for wireless communications is described. The code may include instructions executable by one or more processors to receive signaling indicating a configuration for communications via a first cell group and a second cell group, the first cell group including a first cell used for transmission of UCI associated with the first cell group and the second cell group including a second cell used for transmission of UCI associated with the second cell group and transmit UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

In some examples of the method, user equipment (UEs), and non-transitory computer-readable medium described herein, the parameter associated with the UCI includes a UCI payload type of the UCI.

In some examples of the method, user equipment (UEs), and non-transitory computer-readable medium described herein, the UCI payload type includes hybrid automatic repeat/request acknowledgment (HARQ-ACK) feedback and the HARQ-ACK feedback may be transmitted to the second cell.

In some examples of the method, user equipment (UEs), and non-transitory computer-readable medium described herein, the UCI payload type includes channel state information (CSI) feedback and the CSI feedback may be transmitted to the first cell.

In some examples of the method, user equipment (UEs), and non-transitory computer-readable medium described herein, the UCI payload type includes a scheduling request (SR) and the SR may be transmitted to the second cell.

In some examples of the method, user equipment (UEs), and non-transitory computer-readable medium described herein, the parameter associated with the UCI includes a payload size of the UCI, the UCI may be transmitted to the second cell in accordance with the payload size of the UCI failing to satisfy a threshold payload size, and the UCI may be transmitted to the first cell in accordance with the payload size of the UCI satisfying the threshold payload size.

Some examples of the method, user equipment (UEs), and non-transitory computer-readable medium described herein may further include operations, features, means, or instructions for receiving an indication of a threshold payload size associated with the payload size.

In some examples of the method, user equipment (UEs), and non-transitory computer-readable medium described herein, the parameter associated with the UCI includes the payload size and a UCI payload type.

Some examples of the method, user equipment (UEs), and non-transitory computer-readable medium described herein may further include operations, features, means, or instructions for receiving an indication of the parameter associated with the UCI, where transmitting the UCI to the first cell, to the second cell, or to both the first cell and the second cell may be in accordance with the indication of the parameter.

In some examples of the method, user equipment (UEs), and non-transitory computer-readable medium described herein, the parameter associated with the UCI includes HARQ-ACK feedback associated with the second cell group and the HARQ-ACK feedback may be transmitted to both the first cell and the second cell.

In some examples of the method, user equipment (UEs), and non-transitory computer-readable medium described herein, the HARQ-ACK feedback may be associated with a subset of HARQ process identifiers in a subset of cells of the second cell group.

In some examples of the method, user equipment (UEs), and non-transitory computer-readable medium described herein, a repetition of the HARQ-ACK feedback may be transmitted to both the first cell and the second cell.

Some examples of the method, user equipment (UEs), and non-transitory computer-readable medium described herein may further include operations, features, means, or instructions for receiving an indication activating transmitting the HARQ-ACK feedback associated with the second cell group to both the first cell and the second cell.

Some examples of the method, user equipment (UEs), and non-transitory computer-readable medium described herein may further include operations, features, means, or instructions for receiving an indication activating transmitting the HARQ-ACK feedback associated with the second cell group to the first cell, to the second cell, or to both the first cell and the second cell.

In some examples of the method, user equipment (UEs), and non-transitory computer-readable medium described herein, the HARQ-ACK feedback transmitted to the first cell includes a compressed version of the HARQ-ACK feedback and the HARQ-ACK feedback transmitted to the second cell includes a non-compressed version of the HARQ-ACK feedback.

In some examples of the method, user equipment (UEs), and non-transitory computer-readable medium described herein, the compressed version of the HARQ-ACK feedback includes at least one of a bundled ACK/NACK information according to a logical function performed on a set of bits associated with the HARQ-ACK feedback or a set of statistics associated with the ACK/NACK information.

In some examples of the method, user equipment (UEs), and non-transitory computer-readable medium described herein, the compressed version of the HARQ-ACK feedback may be transmitted to the first cell in the first cell group or to a different cell in the first cell group.

Some examples of the method, user equipment (UEs), and non-transitory computer-readable medium described herein may further include operations, features, means, or instructions for transmitting a UE capability message indicating support for transmitting the UCI to the first cell, to the second cell, or to both the first cell and the second cell.

Some examples of the method, user equipment (UEs), and non-transitory computer-readable medium described herein may further include operations, features, means, or instructions for transmitting the UCI to the first cell, to the second cell, or to both the first cell and the second cell may be in accordance with a channel quality associated with the second cell.

A method for wireless communications by a first cell in a first cell group is described. The method may include outputting, to a UE, signaling indicating a configuration for communications via the first cell group and a second cell group, the first cell group including the first cell used for reception of UCI associated with the first cell group and the second cell group including a second cell used for reception of UCI associated with the second cell group, obtaining, from the UE, UCI associated with the second cell group, where receiving the UCI associated with the second cell group from the UE is in accordance with a parameter associated with the UCI, and outputting the UCI associated with the second cell group to the second cell of the second cell group via a backhaul interface between the first cell and the second cell.

A wireless device associated with a first cell in a first cell group for wireless communications is described. The wireless device may include one or more memories storing processor executable code, and one or more processors coupled with the one or more memories. The one or more processors may individually or collectively be operable to execute the code to cause the first cell in a first cell group to output, to a UE, signaling indicating a configuration for communications via the first cell group and a second cell group, the first cell group including the first cell used for reception of UCI associated with the first cell group and the second cell group including a second cell used for reception of UCI associated with the second cell group, obtain, from the UE, UCI associated with the second cell group, where receiving the UCI associated with the second cell group from the UE is in accordance with a parameter associated with the UCI, and output the UCI associated with the second cell group to the second cell of the second cell group via a backhaul interface between the first cell and the second cell.

Another first cell in a first cell group for wireless communications is described. The first cell in a first cell group may include means for outputting, to a UE, signaling indicating a configuration for communications via the first cell group and a second cell group, the first cell group including the first cell used for reception of UCI associated with the first cell group and the second cell group including a second cell used for reception of UCI associated with the second cell group, means for obtaining, from the UE, UCI associated with the second cell group, where receiving the UCI associated with the second cell group from the UE is in accordance with a parameter associated with the UCI, and means for outputting the UCI associated with the second cell group to the second cell of the second cell group via a backhaul interface between the first cell and the second cell.

A non-transitory computer-readable medium storing code for wireless communications is described. The code may include instructions executable by one or more processors to output, to a UE, signaling indicating a configuration for communications via the first cell group and a second cell group, the first cell group including the first cell used for reception of UCI associated with the first cell group and the second cell group including a second cell used for reception of UCI associated with the second cell group, obtain, from the UE, UCI associated with the second cell group, where receiving the UCI associated with the second cell group from the UE is in accordance with a parameter associated with the UCI, and output the UCI associated with the second cell group to the second cell of the second cell group via a backhaul interface between the first cell and the second cell.

In some examples of the method, first cell in a first cell groups, and non-transitory computer-readable medium described herein, the parameter associated with the UCI includes a UCI payload type of the UCI.

In some examples of the method, first cell in a first cell groups, and non-transitory computer-readable medium described herein, the UCI payload type includes CSI feedback and the CSI feedback may be obtained by the first cell.

In some examples of the method, first cell in a first cell groups, and non-transitory computer-readable medium described herein, the parameter associated with the UCI includes a payload size of the UCI, and the UCI may be obtained by the first cell in accordance with the payload size of the UCI satisfying a threshold payload size.

Some examples of the method, first cell in a first cell groups, and non-transitory computer-readable medium described herein may further include operations, features, means, or instructions for outputting, to the UE, an indication of a threshold payload size associated with the payload size.

In some examples of the method, first cell in a first cell groups, and non-transitory computer-readable medium described herein, the parameter associated with the UCI includes the payload size and a UCI payload type.

Some examples of the method, first cell in a first cell groups, and non-transitory computer-readable medium described herein may further include operations, features, means, or instructions for outputting, to the UE, an indication of the parameter associated with the UCI, where obtaining the UCI from the UE may be in accordance with the indication of the parameter.

In some examples of the method, first cell in a first cell groups, and non-transitory computer-readable medium described herein, the parameter associated with the UCI includes HARQ-ACK feedback associated with the second cell group and the HARQ-ACK feedback may be obtained by both the first cell and the second cell.

In some examples of the method, first cell in a first cell groups, and non-transitory computer-readable medium described herein, the HARQ-ACK feedback may be associate with a subset of HARQ process identifiers in a subset of cells of the second cell group.

In some examples of the method, first cell in a first cell groups, and non-transitory computer-readable medium described herein, a repetition of the HARQ-ACK feedback may be obtained by both the first cell and the second cell.

Some examples of the method, first cell in a first cell groups, and non-transitory computer-readable medium described herein may further include operations, features, means, or instructions for outputting, to the UE, an indication activating transmission of the HARQ-ACK feedback associated with the second cell group to both the first cell and the second cell.

Some examples of the method, first cell in a first cell groups, and non-transitory computer-readable medium described herein may further include operations, features, means, or instructions for obtaining an indication activating transmitting the HARQ-ACK feedback associated with the second cell group to the first cell, to the second cell, or to both the first cell and the second cell.

In some examples of the method, first cell in a first cell groups, and non-transitory computer-readable medium described herein, the HARQ-ACK feedback obtained by the first cell includes a compressed version of the HARQ-ACK feedback and the HARQ-ACK feedback obtained by the second cell includes a non-compressed version of the HARQ-ACK feedback.

In some examples of the method, first cell in a first cell groups, and non-transitory computer-readable medium described herein, the compressed version of the HARQ-ACK feedback includes at least one of a bundled ACK/NACK information according to a logical function performed on a set of bits associated with the HARQ-ACK feedback or a set of statistics associated with the ACK/NACK information.

In some examples of the method, first cell in a first cell groups, and non-transitory computer-readable medium described herein, the compressed version of the HARQ-ACK feedback may be obtained by the first cell in the first cell group or to a different cell in the first cell group.

Some examples of the method, first cell in a first cell groups, and non-transitory computer-readable medium described herein may further include operations, features, means, or instructions for obtaining a UE capability message indicating support for the UE to transmit the UCI to the first cell, to the second cell, or to both the first cell and the second cell.

In some examples of the method, first cell in a first cell groups, and non-transitory computer-readable medium described herein, the UE transmitting the UCI to the first cell, to the second cell, or to both the first cell and the second cell may be in accordance with a channel quality associated with the second cell.

A method for wireless communications by a second cell of a second cell group is described. The method may include obtaining signaling indicating a configuration of a UE for communications via a first cell group and the second cell group, the first cell group including a first cell used for reception of UCI associated with the first cell group and the second cell group including the second cell used for reception of UCI associated with the second cell group, obtaining, from the UE, UCI associated with the second cell group, where reception of the UCI associated with the second cell group is in accordance with a parameter associated with the UCI, and obtaining the UCI associated with the second cell group from the first cell of the first cell group via a backhaul interface between the first cell and the second cell.

A second cell of a second cell group for wireless communications is described. The second cell of a second cell group may include one or more memories storing processor executable code, and one or more processors coupled with the one or more memories. The one or more processors may individually or collectively be operable to execute the code to cause the second cell of a second cell group to obtain signaling indicating a configuration of a UE for communications via a first cell group and the second cell group, the first cell group including a first cell used for reception of UCI associated with the first cell group and the second cell group including the second cell used for reception of UCI associated with the second cell group, obtain, from the UE, UCI associated with the second cell group, where reception of the UCI associated with the second cell group is in accordance with a parameter associated with the UCI, and obtain the UCI associated with the second cell group from the first cell of the first cell group via a backhaul interface between the first cell and the second cell.

Another second cell of a second cell group for wireless communications is described. The second cell of a second cell group may include means for obtaining signaling indicating a configuration of a UE for communications via a first cell group and the second cell group, the first cell group including a first cell used for reception of UCI associated with the first cell group and the second cell group including the second cell used for reception of UCI associated with the second cell group, means for obtaining, from the UE, UCI associated with the second cell group, where reception of the UCI associated with the second cell group is in accordance with a parameter associated with the UCI, and means for obtaining the UCI associated with the second cell group from the first cell of the first cell group via a backhaul interface between the first cell and the second cell.

A non-transitory computer-readable medium storing code for wireless communications is described. The code may include instructions executable by one or more processors to obtain signaling indicating a configuration of a UE for communications via a first cell group and the second cell group, the first cell group including a first cell used for reception of UCI associated with the first cell group and the second cell group including the second cell used for reception of UCI associated with the second cell group, obtain, from the UE, UCI associated with the second cell group, where reception of the UCI associated with the second cell group is in accordance with a parameter associated with the UCI, and obtain the UCI associated with the second cell group from the first cell of the first cell group via a backhaul interface between the first cell and the second cell.

In some examples of the method, second cell of a second cell groups, and non-transitory computer-readable medium described herein, the parameter associated with the UCI includes a UCI payload type of the UCI.

In some examples of the method, second cell of a second cell groups, and non-transitory computer-readable medium described herein, the UCI payload type includes HARQ-ACK feedback and the HARQ-ACK feedback may be obtained by the second cell.

In some examples of the method, second cell of a second cell groups, and non-transitory computer-readable medium described herein, the UCI payload type includes a SR and the SR may be obtained by the second cell.

In some examples of the method, second cell of a second cell groups, and non-transitory computer-readable medium described herein, the parameter associated with the UCI includes a payload size of the UCI.

In some examples of the method, second cell of a second cell groups, and non-transitory computer-readable medium described herein, the UCI may be obtained by the second cell in accordance with the payload size of the UCI failing to satisfy a threshold payload size.

In some examples of the method, second cell of a second cell groups, and non-transitory computer-readable medium described herein, the parameter associated with the UCI includes the payload size and a UCI payload type.

In some examples of the method, second cell of a second cell groups, and non-transitory computer-readable medium described herein, the parameter associated with the UCI includes HARQ-ACK feedback associated with the second cell group and the HARQ-ACK feedback may be obtained by both the first cell and the second cell.

In some examples of the method, second cell of a second cell groups, and non-transitory computer-readable medium described herein, the HARQ-ACK feedback may be associated with a subset of HARQ process identifiers in a subset of cells of the second cell group.

In some examples of the method, second cell of a second cell groups, and non-transitory computer-readable medium described herein, a repetition of the HARQ-ACK feedback may be obtained by both the first cell and the second cell.

In some examples of the method, second cell of a second cell groups, and non-transitory computer-readable medium described herein, the HARQ-ACK feedback obtained by the first cell includes a compressed version of the HARQ-ACK feedback and the HARQ-ACK feedback obtained by the second cell includes a non-compressed version of the HARQ-ACK feedback.

Some examples of the method, second cell of a second cell groups, and non-transitory computer-readable medium described herein may further include operations, features, means, or instructions for adjusting one or more communication parameters for communicating with the UE in accordance with the UCI obtained from the first cell.

In some examples of the method, second cell of a second cell groups, and non-transitory computer-readable medium described herein, the UE transmitting the UCI to the first cell, to the second cell, or to both the first cell and the second cell may be in accordance with a channel quality associated with the second cell.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dual transmission of uplink control in a component carrier group in accordance with one or more aspects of the present disclosure.

FIG. 2 shows an example of a wireless communications system that supports dual transmission of uplink control in a component carrier group in accordance with one or more aspects of the present disclosure.

FIG. 3 shows an example of a wireless communications system that supports dual transmission of uplink control in a component carrier group in accordance with one or more aspects of the present disclosure.

FIG. 4 shows an example of a swim diagram that supports dual transmission of uplink control in a component carrier group in accordance with one or more aspects of the present disclosure.

FIGS. 5 and 6 show block diagrams of devices that support dual transmission of uplink control in a component carrier group in accordance with one or more aspects of the present disclosure.

FIG. 7 shows a block diagram of a communications manager that supports dual transmission of uplink control in a component carrier group in accordance with one or more aspects of the present disclosure.

FIG. 8 shows a diagram of a system including a device that supports dual transmission of uplink control in a component carrier group in accordance with one or more aspects of the present disclosure.

FIGS. 9 and 10 show block diagrams of devices that support dual transmission of uplink control in a component carrier group in accordance with one or more aspects of the present disclosure.

FIG. 11 shows a block diagram of a communications manager that supports dual transmission of uplink control in a component carrier group in accordance with one or more aspects of the present disclosure.

FIG. 12 shows a diagram of a system including a device that supports dual transmission of uplink control in a component carrier group in accordance with one or more aspects of the present disclosure.

FIGS. 13 through 17 show flowcharts illustrating methods that support dual transmission of uplink control in a component carrier group in accordance with one or more aspects of the present disclosure.

### DETAILED DESCRIPTION

Wireless networks may support carrier aggregation (CA) or dual-connectivity (DC) communication techniques where user equipment (UE) are configured with multiple cell groups. For example, the UE may be configured with a primary cell (PCell) of a master cell group (MCG) or a primary secondary cell (PSCell) of a secondary cell group (SCG) (e.g., in DC configurations). Each cell group may have at least one cell designated for receiving physical uplink control channel (PUCCH) transmissions from the UE. The PUCCH transmissions may be used for scheduling communications between the UE and each cell group, for performing link adaptation, or for other techniques. However, in some cases the cells within one or more of the cell groups may not be collocated, which may introduce latency associated with backhaul communications between the cell groups, such as for PUCCH transmissions that relate to another cell group. Accordingly, PUCCH transmissions between non-collocated cell groups may fail to satisfy associated latency requirements.

Accordingly, aspects of the techniques described herein provide for uplink control information (UCI) (e.g., PUCCH transmissions) associated with a second cell group (e.g., a SCG) being provided to a first cell group (e.g., an MCG). For example, a UE may receive or otherwise obtain signaling indicating a configuration for communications via the first cell group and the second cell group. The first cell group may include a first cell used for transmission of UCI associated with the first cell group. The second cell group may include a second cell (e.g., a PSCell) used for transmission of UCI associated with the second cell group. The UE may transmit or otherwise output UCI associated with the second cell group to the first cell in the first cell group, to the second cell in the second cell group, or to both the first cell and the second cell. In some aspects, transmitting the UCI associated with the second cell group to the first cell, to the second cell, or to both the first cell and the second cell may be in accordance with a parameter associated with the UCI. For example, the parameter may include or be based on the UCI payload type, the UCI payload size, or may be network-configured for the UE.

Aspects of the disclosure are initially described in the context of wireless communications systems. Aspects of the disclosure are further illustrated by and described with reference to apparatus diagrams, system diagrams, and flowcharts that relate to dual transmission of uplink control in a component carrier group.

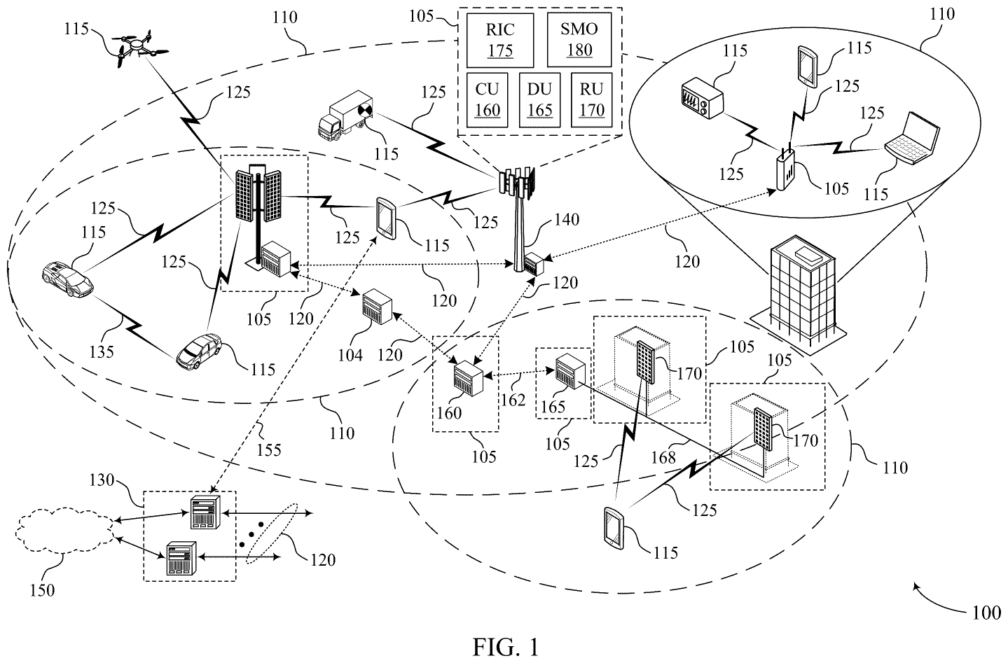

FIG. 1 shows an example of a wireless communications system 100 that supports dual transmission of uplink control in a component carrier group in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive signaling indicating a configuration for communications via a first cell group and a second cell group, the first cell group comprising a first cell used for transmission of UCI associated with the first cell group and the second cell group comprising a second cell used for transmission of UCI associated with the second cell group. The UE 115 may transmit UCI associated with the second cell group to the first cell in the first cell group, to the second cell in the second cell group, or to both the first cell and the second cell, wherein transmitting the UCI associated with the second cell group to the first cell, to the second cell, or to both the first cell and the second cell is in accordance with a parameter associated with the UCI.

A first cell (e.g., a wireless device associated with the first cell, such as a network entity 105) of a first cell group (e.g., a group of network entities 105) may output, to a UE 115, signaling indicating a configuration for communications via the first cell group and a second cell group, the first cell group comprising the first cell used for reception of UCI associated with the first cell group and the second cell group comprising a second cell used for reception of UCI associated with the second cell group. The first cell may obtain, from the UE 115, UCI associated with the second cell group, wherein receiving the UCI associated with the second cell group from the UE 115 is in accordance with a parameter associated with the UCI. The first cell may output the UCI associated with the second cell group to the second cell of the second cell group via a backhaul interface between the first cell and the second cell.

A second cell (e.g., a wireless device associated with the second cell, such as a network entity 105) of a second cell group (e.g., a group of network entities 105) may obtaining signaling indicating a configuration of a UE 115 for communications via a first cell group and the second cell group, the first cell group comprising a first cell used for reception of UCI associated with the first cell group and the second cell group comprising the second cell used for reception of UCI associated with the second cell group. The second cell may obtain, from the UE 115, UCI associated with the second cell group, wherein reception of the UCI associated with the second cell group is in accordance with a parameter associated with the UCI. The second cell may obtain the UCI associated with the second cell group from the first cell of the first cell group via a backhaul interface between the first cell and the second cell.

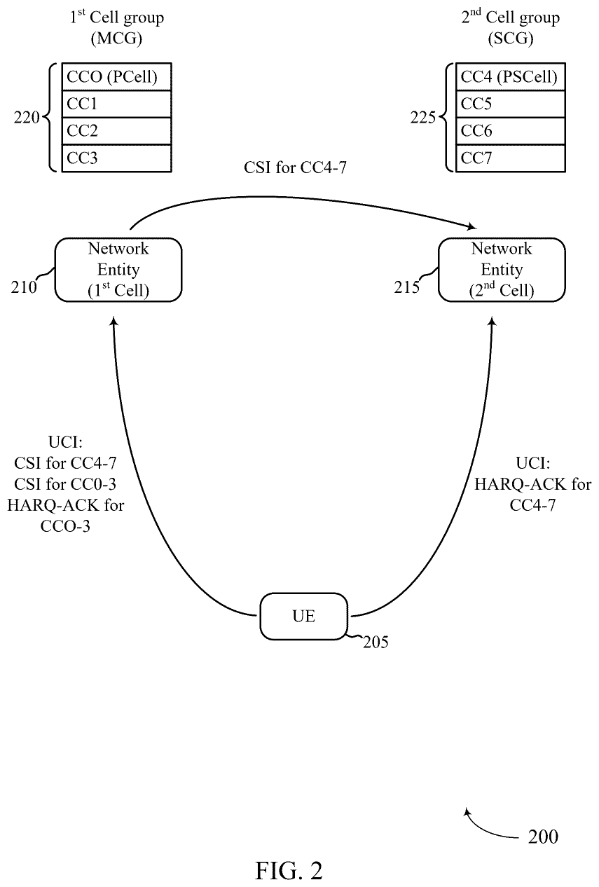

FIG. 2 shows an example of a wireless communications system 200 that supports dual transmission of uplink control in a component carrier group in accordance with one or more aspects of the present disclosure. Wireless communications system 200 may implement aspects of wireless communications system 100. Wireless communications system 200 may include a UE 205, a network entity 210, and a network entity 215, which may be examples of the corresponding devices described herein. For example, the network entity 210 may be an example of a first cell of a first cell group and the network entity 215 may be an example of a second cell of a second cell group.

The UE 205 may be configured to communicate via multiple cell groups. One example of multiple cell groups may include the UE 205 being configured to communicate via a DC configuration. The DC configuration may include the UE 205 being configured with an MCG and one or more SCGs. The MCG may have one or more cells and each SCG may have one or more cells. Another example of multiple cells may include the UE 205 being configured to communicate via a CA configuration. The CA configuration may include the UE 205 being configured with a first cell group and a second cell group. Each of the first cell group and the second cell group may include one or more cells. In some aspects, each cell in a cell group may also be associated with a CC used for communications between the UE and that cell. Accordingly, references to a cell and a CC may be used interchangeably.

In some aspects, the UE 205 configured for communications via multiple cells groups may include multiple PUCCH groups. For example, the UE 205 may be configured with two PUCCH groups in DC or CA configurations. For DC configurations, the PUCCH of all CCs in the MCG may be sent on the PCell and the PUCCH of all CCs in the SCG(s) are sent on the PSCell (e.g., the PCell of the SCG). For CA configurations, in some cases the PUCCH of all cells within a cell group is sent on the PSCell or PUCCH cell of that cell group (e.g., one PUCCH group). In other CA cases, two PUCCH groups may be configured for the UE 205, which may be based on the capability of the UE 205. For example, the UE 205 configured for CA communications may be configured with a primary PUCCH group including a PCell and one or more SCells (e.g., similar to the MCG in DC configurations) as well as a secondary PUCCH group that includes a PUCCH SCell as well as one or more SCells (e.g., similar to the SCG in DC configurations).

The PUCCH cell for a cell group is generally configured as part of the PDSCH-ServingCellConfig parameter. For example, the UE 205 may use this parameter to identify or otherwise determine the serving cell index for the PUCCH cell that carries PUCCH for this serving cell. That is, the PDSCH-ServingCellConfig parameter may carry or otherwise convey information that identifies the pucch-Cell ServCellIndex used by the UE 205 to determine the serving cell index (e.g., to identify the PUCCH cell for that cell group).

In some aspects, the uplink coverage area associated with multi-cell group configurations for the UE 205 may differ. For example, when the CA deployment is feasible, the cell groups may include collocated cells within a single or coordinated DU (e.g., intra-frequency CA) deployment or, otherwise, a non-collocated cell deployment may be used with a low latency backhaul interface between the cells. In such cases, multiplexing uplink control information for all carriers (cells or CCs) may be dynamically performed on the anchor cell (e.g., PCell or PUCCH cell). This reducing the downlink/uplink imbalance may rely on a low-band coverage layer for the uplink given that all uplink control information may be carried on a cell (CC) in a lower band with more favorable propagation conditions.

When meeting the deployment requirements for CA (with single PUCCH group) is not feasible, some wireless networks may choose a DC configuration (or multiple PUCCH groups with CA) instead. For example, this is the case for all existing deployments for FR1 and FR2 that require aggregation for the UE 205. With DC (or multiple PUCCH groups with CA), the downlink coverage of each cell group may be limited by its own uplink coverage (e.g., as the uplink control is sent on a CC in the same cell group). High throughput of high-band spectrum cell deployments may be realized in favorable coverage regions. Accordingly, this may result in a need to enhance the uplink coverage in non-collocated deployment scenarios.

Accordingly, in some cases uplink coverage enhancement for CA or DC configurations may be needed (e.g., how to provide a low-band anchor in non-collocated/non-coordinated multi-carrier systems). This may include the uplink feedback (e.g., HARQ information bits, RLC status PDU, and the like) for the high-band cell group to be sent on the low-band CC with a better or extended coverage. For example, the HARQ bits can be sent as a group ACK/NACK and protected with CRC. Semi-statically reserving some resources for the high-band cell group on a low-band anchor cell (e.g., the PCell of the MCG in DC) may be used. However, the backhaul latency may be dependent on the deployment and the interface used (e.g., may be commonly assumed to be around 10-20 ms). For such relatively large backhaul latency, increasing the number of HARQ processes to fill the scheduling gaps may not always be feasible (e.g., in high frequency bands with large SCS). For example, this may also impact buffering and HARQ management by the UE 205.

Accordingly, in some situations the UE 205 may be configured with a first cell group that the UE 205 communicates with on a low-band DU/RU. This may be considered the MCG in a DC configuration or the first PUCCH group in a CA configuration with two PUCCH groups. The PUCCH cell for this first cell group is the PCell (e.g., a first cell in the first cell group, in this example) that carries the uplink control (e.g., UCI) on PUCCH for all downlink CCs in this first cell group.

The UE 205 may also be configured with a second cell group that the UE 205 communicates with on a high-band DR/RU. This may be considered the SCG in a DC configuration or a second PUCCH group in a CA configuration with two PUCCH groups. The PUCCH cell (e.g., a second cell in this second cell group) for this second cell group is the PSCell (e.g., in case of DC) or PUCCH SCell (e.g., in case of CA with two PUCCH cell groups), which carries the uplink control (e.g., UCI) on PUCCH for all downlink CCs in this second cell group. The uplink coverage for this PUCCH cell (e.g., the high-band cell, or second cell of the second cell group) may be limited.

To enhance the uplink coverage in this scenario, some wireless networks may use different approaches. One approach may include additional uplink resources being allocated for PUCCH transmissions to the high-band DU/RU (e.g., on the PSCell in the SCG). However, this approach requires more symbols and more PUCCH repetitions. Thus, this approach increases the uplink overhead, which takes resources from the downlink on the high-band cell group (e.g., the second cell group). Another approach may include the uplink control for the downlink CCs in the high-band cell group (e.g., the second cell group) are instead sent to the low-band DU/RU (e.g., on the PCell). However, the low-band RU/DU (e.g., the first cell of the first cell group) needs to forward this information to the high-band RU/DU (e.g., the second cell of the second cell group), which may result in some delay given the relatively large backhaul latency such as in a non-collocated deployment scenario.

Accordingly, aspects of the techniques described herein provide improvements to both approaches and overcome the drawbacks associated with each of them individually. For example, in some cases the UCIs that are not delay sensitive are sent on the PCell (e.g., the first cell of the first cell group, which may be the low-band cell group) to free up resources on the second PUCCH cell (e.g., the second cell of the second cell group, which may be the high-band cell group) such that the delay sensitive UCIs may be sent directly to the high-band DU/RU. In some cases, the HARQ-ACK may be sent on both PUCCH cells (on both the high-band and the low-band cell group). This may achieve low latency opportunistically on the high-band cell group with a backup on the low-band cell group. In some aspects, this may include sending a compressed version of the HARQ-ACK on the PCell of the low-band cell group for the purpose of link adaptation by the high-band cell group, which is not delay sensitive as this is not used for HARQ retransmissions.

For example, the UE 205 may receive or otherwise obtain (and the network entity 210 may transmit or otherwise output) signaling indicating a configuration for communications via a first cell group and a second cell group. The signaling may include RRC signaling or other signaling between the UE 205 and the network entity 210. The configuration for multi-cell group communications may include configuring the UE 205 for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE 205) of UCI associated with the first cell group. The network entity 210 may be an example of the first cell in the first cell group in this example. For example, the first cell group may include one or more cells or CCs, such as a CC group 220 that includes CC0, CC1, CC2, and CC3, which may collectively be referred to as CC0-3.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of UCI associated with the second cell group. The network entity 215 may be an example of the second cell in the second cell group in this example. For example, the second cell group may include one or more cells or CCs, such as a CC group 225 that includes CC4, CC5, CC6, and CC7, which may collectively be referred to as CC4-7.

In some aspects, the UE 205 may transmit or otherwise output UCI associated with the second cell group to the first cell in the first cell group, to the second cell in the second cell group, or to both the first cell and the second cell. In some aspects, transmitting the UCI associated with the second cell group to the first cell, to the second cell, or to both the first cell and the second cell may be in accordance with a parameter associated with the UCI. Accordingly, in some examples the network entity 210 may receive or otherwise obtain, the network entity 215 may receive or otherwise obtain, or both network entities may receive or otherwise obtain the UCI associated with the second cell group from the UE 205.

In some aspects, the UE 205 may further transmit or otherwise output UCI associated with the first cell group to the first cell (e.g., to the network entity 210). The UE 205 may further transmit or otherwise output UCI associated with the second cell group to the second cell (e.g., to the network entity 215). As one non-limiting example, the UCI that the UE 205 communicates to the network entity 210 of the first cell group may include CSI for CC4-7 (e.g., associated with the second cell group), CSI for CC0-3 (e.g., associated with the first cell group), HARQ-ACK for CC0-3 (e.g., associated with the first cell group). As another non-limiting example, the UCI that the UE 205 communicates to the network entity 215 of the second cell group may include the HARQ-ACK for CC4-7 (e.g., associated with the second cell group).

In the example where the network entity 210 receives the UCI associated with the second cell group, the network entity 210 may transmit or otherwise output the UCI (e.g., in full or partially, with or without decoding, processing, or performing other functions) to the network entity 215 (e.g., via a backhaul interface). As one non-limiting example, the network entity 210 may transmit or otherwise output (and the network entity 215 may receive or otherwise obtain) the CSI for CC4-7.

Accordingly, in some aspects the techniques described herein provide for some UCIs associated with the second cell group (e.g., the SCG in DC or second PUCCH group in CA) to be sent on the PUCCH cell of the same cell group (e.g., PSCell in DC or PUCCH SCell in CA), where other UCIs associated with the second cell group are sent on the PUCCH cell of the first cell group (e.g., the PCell in DC or PUCCH cell in CA with two PUCCH cell groups). Which UCI(s) associated with the second cell group are to be sent on the PUCCH cell of the same cell group, on the first cell group, or both cell groups, may be based on the parameter associated with the UCI.

In some cases, the parameter associated with the UCI may include a UCI payload type of the UCI (e.g., based on the UCI payload type of the UCI associated with the second cell group). For example, when the UCI payload type is HARQ-ACK feedback associated with the second cell group the HARQ-ACK feedback may be transmitted to the second cell (e.g., the network entity 215) of the second cell group (e.g., as is shown in FIG. 2). That is, the HARQ-ACK feedback may be sent on the PUCCH cell of the same cell group (e.g., since the impact of the backhaul latency on HARQ round-trip-time (RTT) may not be tolerable) in some examples. When the UCI payload type is a scheduling request (SR) associated with the second cell group, the SR may be transmitted to the second cell (e.g., the network entity 215) of the second cell group. For example, the SR may be sent to the PUCCH cell of the same cell group (e.g., as the latency may be also important for the SR and the payload size of the SR is typically small).

When the UCI payload type is CSI feedback associated with the second cell group, the CSI feedback may be transmitted to the first cell (e.g., the network entity 210) of the first cell group (e.g., as is shown in FIG. 2). For example, the CSI (e.g., periodic-CSI or semi-persistent CSI on PUCCH) may be sent on the PUCCH cell of the first cell group. The CSI may be sent on some reserved or dedicated PUCCH resources on the PUCCH cell (e.g., the network entity 210) of the first cell group. The CSI may also be multiplexed with UCIs (e.g., HARQ-ACK, CSI, SR) associated with the first cell group (e.g., the first cell group's own UCI) in a PUCCH transmission. The CSI may be multiplexed with a PUSCH scheduled on the cell within the first cell group (e.g., when the PUCCH resource overlaps with the PUSCH transmission).

In some aspects, the latency associated with the CSI may not be critical. Accordingly, the low-band DU (e.g., the first cell) can decode the PUCCH and send it to the high-band DU (e.g., the second cell) over the backhaul interface. At the same time, moving the CSI feedback of the high-band cell group to the PUCCH of the low-band cell group will free up resources on the high-band cell group so that more symbols or repetitions can be used for critical UCIs such as HARQ-ACK to address the uplink coverage issue of the high-band cell group (e.g., the second cell group).

In some cases, the parameter associated with the UCI may include a payload size of the UCI. For example, the UCI associated with the second cell group may be transmitted to the second cell (e.g., the network entity 215) when the payload size of the UCI fails to satisfy a threshold payload size or may be transmitted to the first cell (e.g., the network entity 210) when the payload size of the UCI satisfies the threshold payload size.

That is, the determination of whether the UCI is transmitted to the first cell, to the second cell, or to both the first cell and the second cell may be based on the payload size of the UCI associated with the second cell group. If the payload size is less than the threshold payload size, the UCI may be sent on the PUCCH cell of the second cell group. If the payload size is larger than the threshold payload size, the UCI may be sent of the PUCCH cell of the first (e.g., the other) cell group. In some aspects, the threshold payload size may be RRC configured for the UE 205. For example, the UE 205 may receive or otherwise obtain (and the network entity 210 may transmit or otherwise output) an indication of the threshold payload size associated with the payload size. In some aspects, it may be that coverage of the uplink PUCCH on the high-band PUCCH may be a bottleneck if the UCI payload size is larger than a certain amount. If so, the UCI may be sent on the low-band PUCCH. Otherwise, it may be sent on the high-band PUCCH.

In some cases, the parameter associated with the UCI may be both the UCI payload type (e.g., as discussed above) and the payload size. For example, for CSI with a small payload size, it may be sent on the PUCCH cell of the second cell group. For CSI with a large payload size, it may be sent on the PUCCH cell of the first cell group.

In some cases, the parameter associated with the UCI may be based on a network configuration or indication for the UCI associated with the second cell group. For example, the UE 205 may receive or otherwise obtain (and the network entity 210 may transmit or otherwise output) an indication of the parameter associated with the UCI. The UE 205 may transmit the UCI to the first cell, to the second cell, or to both the first cell and the second cell in accordance with the indication of the parameter.

For example, the network may use various signaling to configure or otherwise indicate whether a given UCI associated with the second cell group should be transmitted on the PUCCH cell of the second cell group or the first cell group. Such signaling may include RRC signaling, MAC-CE signaling, or DCI signaling. This approach may provide additional flexibility. For example, the backhaul latency may change depending on the network load and the uplink coverage of the high-band cell group may change as the UE 205 moves. Accordingly, the network may switch (e.g., by RRC/MAC-CE/DCI signaling) the transmission of the HARQ-ACK for the SCG between PUCCH of SCG and PUCCH of MCG. As another example, a first periodic CSI of the SCG may not be delay tolerant (e.g., CSI for downlink CC in SCG may be used for URLLC or XR traffic) while a second periodic CSI of the SCG may be delay tolerant. Accordingly, the network may configure the first CSI to be sent over the PUCCH of the SCG (PSCell) and configure the second CSI to be sent over the PUCCH of the MCG (PCell).

In some aspects, the techniques described herein may be based on an indication of UE capability signaling. For example, the UE 205 may transmit or otherwise output (and the network entity 210 may receive or otherwise obtain) a UE capability message that indicates support for transmitting the UCI to the first cell, to the second cell, or to both the first cell and the second cell. The network may use the UE capability message when configuring the UE for multi-cell group communications.

In some aspects, the techniques described herein may be based on or otherwise conditioned on a RSRP value of a downlink reference signal (e.g., SSB or CSI-RS) for a CC in the second cell group. For example, the UE 205 transmitting the UCI to the first cell, to the second cell, or to both the first cell and the second cell may be in accordance with a channel quality associated with the second cell or the second cell group. The CC may be any CC in the second cell group, a specific CC (e.g., RRC configured) in the second cell group, or the CC of the PUCCH cell of the second cell group. If the RSRP value is larger than a threshold, all UCIs of the second cell group may be sent on the PUCCH cell (e.g. the second cell) of the second cell group. For example, the larger RSRP value may indicate that the uplink coverage of the high-band cell group is satisfactory and, therefore, no need to send corresponding UCIs to a different PUCCH cell in a different cell group. If the RSRP value is smaller than a threshold, some UCIs of the second cell group may be sent to the PUCCH cell of the first cell group. The RSRP threshold may be RRC configured for the UE 205.

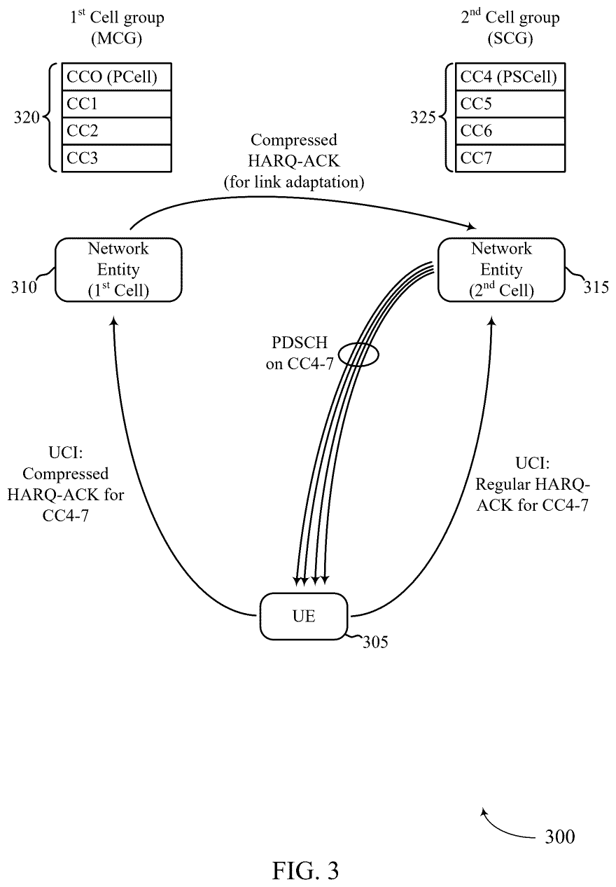

FIG. 3 shows an example of a wireless communications system 300 that supports dual transmission of uplink control in a component carrier group in accordance with one or more aspects of the present disclosure. Wireless communications system 300 may implement aspects of wireless communications system 100 or wireless communications system 200. Wireless communications system 300 may include a UE 305, a network entity 310, and a network entity 315, which may be examples of the corresponding devices described herein. For example, the network entity 310 may be an example of a first cell of a first cell group and the network entity 315 may be an example of a second cell of a second cell group.

As discussed above, the UE 305 may receive or otherwise obtain (and the network entity 310 may transmit or otherwise output) signaling indicating a configuration for communications via a first cell group and a second cell group. The signaling may include RRC signaling or other signaling between the UE 305 and the network entity 310. The configuration for multi-cell group communications may include configuring the UE 305 for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE 305) of UCI associated with the first cell group. The network entity 310 may be an example of the first cell in the first cell group in this example. For example, the first cell group may include one or more cells or CCs, such as a CC group 320 that includes CC0, CC1, CC2, and CC3, which may collectively be referred to as CC0-3.

The second cell group may be a SCG in the DC scenario or a second PUCCH group in the CA scenario with two PUCCH groups. The second cell group may include a second cell that may be the PSCell in the DC scenario or the PUCCH-SCell in the CA scenario with two PUCCH groups (e.g., carries uplink control on PUCCH for all downlink CCs in this cell group). For example, the second cell may be used for transmission of UCI associated with the second cell group. The network entity 315 may be an example of the second cell in the second cell group in this example. For example, the second cell group may include one or more cells of CCs, such as a CC group 325 that includes CC4, CC5, CC6, and CC7, which may collectively be referred to as CC4-7.

In some aspects, the UE 305 may transmit or otherwise output UCI associated with the second cell group to the first cell in the first cell group, to the second cell in the second cell group, or to both the first cell and the second cell. In some aspects, transmitting the UCI associated with the second cell group to the first cell, to the second cell, or to both the first cell and the second cell may be in accordance with a parameter associated with the UCI. Accordingly, in some examples the network entity 310 may receive or otherwise obtain, the network entity 315 may receive or otherwise obtain, or both devices may receive or otherwise obtain the UCI associated with the second cell group from the UE 305.

In some aspects, the UE 305 may further transmit or otherwise output UCI associated with the first cell group to the first cell (e.g., to the network entity 310). Moreover, the UE 305 may further transmit or otherwise output UCI associated with the second cell group to the second cell (e.g., to the network entity 315). As one non-limiting example, the UCI that the UE 305 communicates to the network entity 310 of the first cell group may include CSI for CC4-7 (e.g., associated with the second cell group), CSI for CC0-3 (e.g., associated with the first cell group), HARQ-ACK for CC0-3 (e.g., associated with the first cell group). As another non-limiting example, the UCI that the UE 305 communicates to the network entity 315 of the second cell group may include the HARQ-ACK for CC4-7 (e.g., associated with the second cell group).

In the example where the network entity 310 receives the UCI associated with the second cell group, the network entity 310 may transmit or otherwise output the UCI (e.g., in full or partially, with or without decoding, processing, or performing other functions) the UCI to the network entity 315 (e.g., via a backhaul interface). As one non-limiting example, the network entity 310 may transmit or otherwise output (and the network entity 315 may receive or otherwise obtain) the CSI for CC4-7.

Accordingly, in some aspects the techniques described herein provide for some UCIs associated with the second cell group (e.g., the SCG in DC or second PUCCH group in CA) to be sent on the PUCCH cell of the same cell group (e.g., PSCell in DC or PUCCH SCell in CA), which other UCIs associated with the second cell group are sent on the PUCCH cell of the first cell group (e.g., the PCell). Which UCI(s) associated with the second cell group are to be sent on the PUCCH cell of the same cell group, on the first cell group, or both cell groups, may be based on the parameter associated with the UCI.

FIG. 3 illustrates a non-limiting example where the parameter associated with the UCI is HARQ-ACK feedback associated with the second cell group. For example, the second cell group may perform a number of downlink transmissions (e.g., PDSCH transmission) on CC4-7 to the UE 305. The downlink transmissions may be HARQ-based transmissions associated with corresponding HARQ process identifiers. The UE 305 may monitor for and receive the downlink transmissions and identify or otherwise determine HARQ feedback (e.g., ACK/NACK indications) for the downlink transmissions. The UE 305 may transmit or otherwise output the HARQ-ACK feedback associated with the second cell group to the first cell (e.g., the network entity 310) of the first cell group and to the second cell (e.g., the network entity 315) of the second cell group. In some examples, the UCI transmitted to the first cell and to the second cell may include the same HARQ-ACK feedback (e.g., full or regular HARQ-ACK feedback) for CC4-7. The first cell may transmit or otherwise output the full or regular version of the HARQ-ACK feedback to the second cell via a backhaul interface. The second cell may use the HARQ-ACK feedback received from the UE 305 and from the first cell for HARQ-ACK operations for the PDSCH message transmissions corresponding to the HARQ process identifiers.

In some examples, the UCI transmitted to the first cell may include a compressed version of the HARQ-ACK feedback for CC4-7 and the UE 305 may transmit full or regular HARQ-ACK feedback for CC4-7 to the second cell. The first cell may transmit or otherwise output the compressed version of the HARQ-ACK feedback to the second cell via a backhaul interface.

The second cell may use the compressed version of the HARQ-ACK feedback for link adaptation, in some examples. For example, the second cell may modify or otherwise adjust various communication parameters used for communications between the UE 305 and the cells of the second cell group based on the compressed version of the HARQ-ACK feedback. Examples of the communication parameters include, but are not limited to, an MCS, a data rate, end-to-end distortion metrics and modeling, frequency-selective scheduling and uplink sounding/SRS transmissions.

Accordingly, wireless communications system 300 illustrates a non-limiting example of HARQ-ACK for the second cell group (e.g., SCG in DC or second PUCCH group in CA) being sent both on the PUCCH cell of the same cell group (e.g., PSCell in DC or PUCCH cell in CA) as well as on the PUCCH cell of the first cell group (e.g., PCell). In some aspects, this may be for all HARQ process identifiers/CCs of the second cell group or for a subset of HARQ process identifiers/CCs of the second cell group. That is, the HARQ-ACK feedback may be associated with a subset of HARQ process identifiers (or CCs) in a subset of cells of the second cell group. This may mitigate the overhead for the HARQ-ACK feedback reporting, such as when compared to all HARQ-ACK payloads (e.g., for all HARQ process identifiers/CCs). The HARQ-ACK feedback reporting may be performed for the subset of the HARQ process identifiers/CCs.

For the other HARQ process identifiers/CCs, this HARQ-ACK feedback may be sent either on the PSCell (e.g., to the second cell) or on the PCell (e.g., to the first cell), but not necessarily both cells. For example, if the HARQ-ACK payload includes ACK/NACK for HARQ process identifiers 0-7 for CCs in the second cell group, this may be sent on both PUCCH cells. If the HARQ-ACK payloads includes ACK/NACK for HARQ process identifiers 8-15 for CCs in the second cell group, this may be sent to the PCell only or to the PSCell only.

In some aspects, a repetition of the HARQ-ACK feedback may be transmitted to both the first cell (e.g., the network entity 310) and to the second cell (e.g., the network entity 315). For example, PUCCH repetition on different CCs for the HARQ-ACK payload may be used. The same HARQ-ACK feedback (e.g., codebook) may be sent on both PUCCH cells. Normal or low latency HARQ-ACK feedback may be realized opportunistically (e.g., when the HARQ-ACK feedback sent to the second cell is decoded), but still the high reliability HARQ-ACK feedback (e.g., the HARQ-ACK feedback sent to the PCell with better uplink coverage) may be used in case the other HARQ-ACK feedback is not decoded. The first cell may transmit or otherwise output the full or regular version of the HARQ-ACK feedback (e.g., the same HARQ-ACK feedback) to the second cell via a backhaul interface.

For example, aspects of transmitting the HARQ-ACK feedback to the first cell, to the second cell, or to both the first cell and the second cell may be enabled for the UE 305. In some examples, the network may RRC configure this mode of operation for the UE 305. In some examples, the network may activate this mode of operation for the UE 305 using MAC-CE signaling. In some examples, the network may dynamically (e.g., using a DCI) indicate for a given scheduled HARQ-ACK whether it should be transmitted on both PUCCH cells, only on its own PUCCH cell (e.g., the second cell), or only on the PUCC cell of the first group.

In these examples, when the HARQ-ACK is sent on both PUCCH cells the DCI may indicate the two PUCCH resources. For example, the downlink DCI may indicate two PUCCH resource indicators (PRIs), where the first PRI identifies a PUCCH resources on the PUCCH cell of the second cell group and the second PRI identifies a PUCCH resource on the PUCCH cell of the first cell group. As another example, the downlink DCI may identify one PRI where the codepoint of the PRI identifies a pair of PUCCH resources (e.g., PUCCH resources for the PUCCH cell of each cell group). For example, the UE 305 may receive or otherwise obtain an indication activating transmitting the HARQ-ACK feedback associated with the second cell group to both the first cell and the second cell. Additionally, or alternatively, the UE 305 may receive or otherwise obtain an indication activating transmitting the HARQ-ACK feedback associated with the second cell group to the first cell, to the second cell, or to both the first cell and the second cell.

In some examples and as is shown in FIG. 3, the HARQ-ACK feedback transmitted to the first cell is a compressed version of the HARQ-ACK feedback and the HARQ-ACK feedback transmitted to the second cell is a non-compressed version (e.g., the normal or regular HARQ-ACK codebook) of the HARQ-ACK feedback. The information sent on the PCell (e.g., the first cell) may not be used for HARQ retransmissions (e.g., due to the large backhaul latency). Instead, this compressed version sent to the first cell may be used for link adaptation, MCS selection, and the like, for the PDSCH transmissions scheduled in the second cell group. For example, the second cell may adjust, select, or modify various communication parameters used for communications between the UE 305 and the cells of the second cell group based on the compressed version of the HARQ-ACK feedback received from the first cell.

For example, the normal HARQ-ACK feedback (e.g., when decoded) may be used by the second cell for HARQ retransmissions opportunistically. The compressed version of the HARQ-ACK feedback provided to the second cell via the backhaul interface from the first cell may be sent less often (e.g., ever tens of ms). In some aspects, the compressed version of the HARQ-ACK feedback may include, but is not limited to, a bundled version of the ACK/NACK results. For example, the bundled ACK/NACK information may be based on a logical function performed on a set of bits (e.g., the codebook) associated with the HARQ-ACK feedback.

In some aspects, the compressed version of the HARQ-ACK feedback may be based on a set of statistics associated with the ACK/NACK information. For example, the compressed version of the HARQ-ACK feedback may include the long-term statistics of the ACK/NACK, such as the number of NACKs or ACKs in a time window or a ratio of the number of NACKs or ACKs to the total number of PDSCHs received in the second cell group.

Accordingly, in this example the compressed version of the HARQ-ACK feedback transmitted to the first cell may have a different time granularity (e.g., much sparser) compared to the normal HARQ-ACK feedback payload transmitted to the second cell (which is dynamically scheduled by DCIs). The network may configure a periodicity for transmission of this compressed version of the HARQ-ACK feedback associated with the second cell group to the first cell (e.g., using periodic PUCCH resources on the PCell). The network may configure a threshold number of received PDSCHs on the second cell group after which the compressed version of the HARQ-ACK feedback is sent to the first cell. The network may indicate (e.g., by DCI or MAC-CE) when the UE 305 should transmit the compressed version of the HARQ-ACK feedback (as well as the time/frequency resources for this transmission to the PCell).

In some examples, the compressed version of the HARQ-ACK feedback associated with the second cell group may be sent via MAC-CE (e.g., in a PUSCH transmission). In this example, the compressed version of the HARQ-ACK feedback may be sent on any uplink CC in the first cell group (e.g., does not have to be sent to the PUCCH cell or PCell). For example, the compressed version of the HARQ-ACK feedback may be transmitted to the first cell in the first cell group or to a different cell in the first cell group. When the compressed version of the HARQ-ACK feedback is transmitted on a PUCCH resource as UCI, this information may be sent on the PUCCH cell of the first cell group.

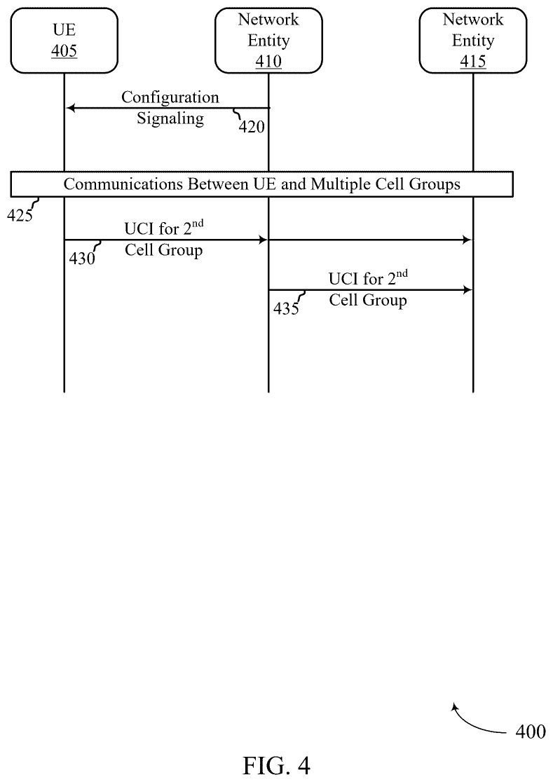

FIG. 4 shows an example of a swim diagram 400 that supports dual transmission of uplink control in a component carrier group in accordance with one or more aspects of the present disclosure. Swim diagram 400 may implement aspects of wireless communications system 100, wireless communications system 200, or wireless communications system 300. Aspects of swim diagram 400 may be performed at or by a UE 405, a network entity 410, and a network entity 415, which may be examples of the corresponding devices described herein. For example, the network entity 410 may be an example of a first cell of a first cell group and the network entity 415 may be an example of a second cell of a second cell group.

At 420, the UE 405 may receive or otherwise obtain (and the network entity 410 may transmit or otherwise output) signaling indicating a configuration for communications via a first cell group and a second cell group. The signaling may include RRC signaling or other signaling between the UE 405 and the network entity 410. The configuration for multi-cell group communications may include configuring the UE 405 for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE 405) of UCI associated with the first cell group. The network entity 410 may be an example of the first cell in the first cell group in this example.

The second cell group may be a SCG in the DC scenario or a second PUCCH group in the CA scenario with two PUCCH groups. The second cell group may include a second cell that may be the PSCell in the DC scenario or the PUCCH-SCell in the CA scenario with two PUCCH groups (e.g., carries uplink control on PUCCH for all downlink CCs in this cell group). For example, the second cell may be used for transmission of UCI associated with the second cell group. The network entity 415 may be an example of the second cell in the second cell group in this example.

At 425, the UE 405 may perform wireless communications via the first cell group and the second cell group. For example, the wireless communications may include PDSCH transmissions to the UE 405 from each cell or CC in each cell group.

At 430, the UE 405 may transmit or otherwise output UCI associated with the second cell group to the first cell in the first cell group, to the second cell in the second cell group, or to both the first cell and the second cell. In some aspects, transmitting the UCI associated with the second cell group to the first cell, to the second cell, or to both the first cell and the second cell may be in accordance with a parameter associated with the UCI. Accordingly, in some examples the network entity 410 may receive or otherwise obtain, the network entity 415 may receive or otherwise obtain, or both devices may receive or otherwise obtain the UCI associated with the second cell group from the UE 405.

In the example where the network entity 410 receives the UCI associated with the second cell group, at 435 the network entity 410 may transmit or otherwise output the UCI (e.g., in full or partially, with or without decoding, processing, or performing other functions) the UCI to the network entity 415 (e.g., via a backhaul interface). As one non-limiting example, the network entity 410 may transmit or otherwise output (and the network entity 415 may receive or otherwise obtain) the CSI for CC4-7 or a compressed version of HARQ-ACK feedback associated with the second cell group.

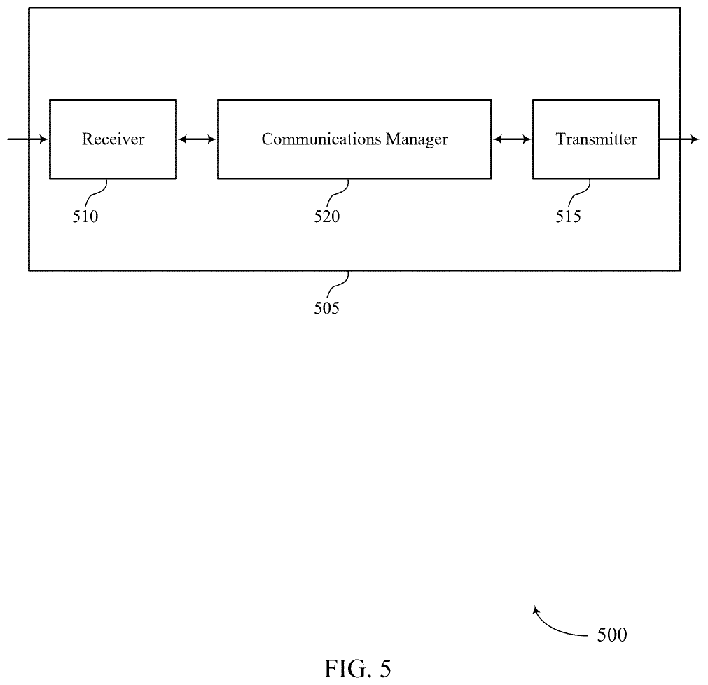

FIG. 5 shows a block diagram 500 of a device 505 that supports dual transmission of uplink control in a component carrier group in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to dual transmission of uplink control in a component carrier group). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dual transmission of uplink control in a component carrier group). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of dual transmission of uplink control in a component carrier group as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving signaling indicating a configuration for communications via a first cell group and a second cell group, the first cell group including a first cell used for transmission of UCI associated with the first cell group and the second cell group including a second cell used for transmission of UCI associated with the second cell group. The communications manager 520 is capable of, configured to, or operable to support a means for transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for UCI transmissions in a multi-cell group communication scenario to either the PUCCH cell of a first cell group, to the PUCCH cell of a second cell group, or to both PUCCH cells. The UCI transmissions may be based on a parameter associated with the UCI, which may provide a balanced mechanism to effectively utilize PUCCH resources in both cell groups while maintaining latency and reliability metrics.

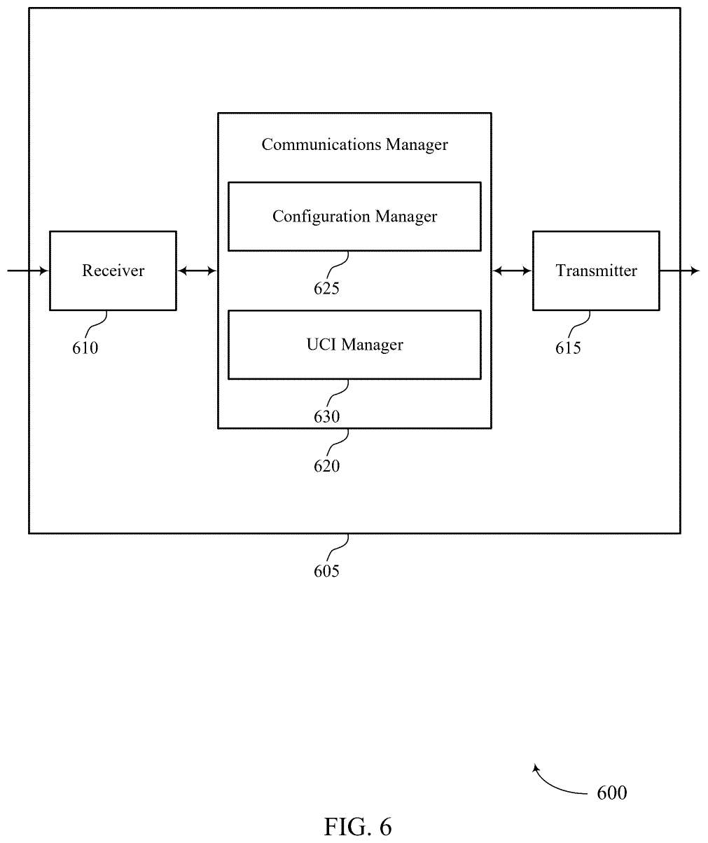

FIG. 6 shows a block diagram 600 of a device 605 that supports dual transmission of uplink control in a component carrier group in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dual transmission of uplink control in a component carrier group). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dual transmission of uplink control in a component carrier group). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of dual transmission of uplink control in a component carrier group as described herein. For example, the communications manager 620 may include a configuration manager 625 a UCI manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration manager 625 is capable of, configured to, or operable to support a means for receiving signaling indicating a configuration for communications via a first cell group and a second cell group, the first cell group including a first cell used for transmission of UCI associated with the first cell group and the second cell group including a second cell used for transmission of UCI associated with the second cell group. The UCI manager 630 is capable of, configured to, or operable to support a means for transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

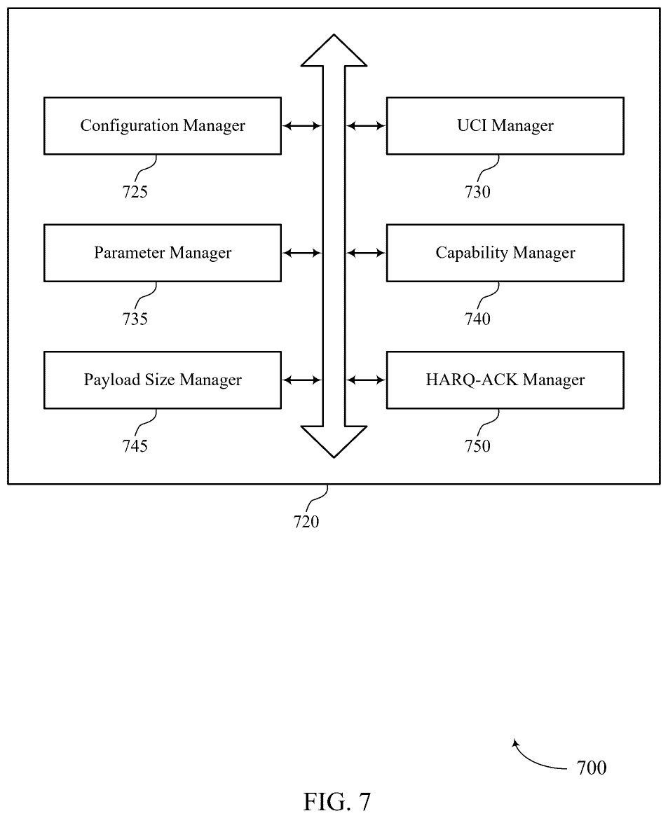

FIG. 7 shows a block diagram 700 of a communications manager 720 that supports dual transmission of uplink control in a component carrier group in accordance with one or more aspects of the present disclosure. The communications manager 720 may be an example of aspects of a communications manager 520, a communications manager 620, or both, as described herein. The communications manager 720, or various components thereof, may be an example of means for performing various aspects of dual transmission of uplink control in a component carrier group as described herein. For example, the communications manager 720 may include a configuration manager 725, a UCI manager 730, a parameter manager 735, a capability manager 740, a payload size manager 745, an HARQ-ACK manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration manager 725 is capable of, configured to, or operable to support a means for receiving signaling indicating a configuration for communications via a first cell group and a second cell group, the first cell group including a first cell used for transmission of UCI associated with the first cell group and the second cell group including a second cell used for transmission of UCI associated with the second cell group. The UCI manager 730 is capable of, configured to, or operable to support a means for transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

In some examples, the parameter associated with the UCI includes a UCI payload type of the UCI. In some examples, the UCI payload type includes HARQ-ACK feedback and the HARQ-ACK feedback is transmitted to the second cell. In some examples, the UCI payload type includes CSI feedback and the CSI feedback is transmitted to the first cell. In some examples, the UCI payload type includes a SR and the SR is transmitted to the second cell.

In some examples, the parameter associated with the UCI includes a payload size of the UCI, the UCI is transmitted to the second cell in accordance with the payload size of the UCI failing to satisfy a threshold payload size, and the UCI is transmitted to the first cell in accordance with the payload size of the UCI satisfying the threshold payload size. In some examples, the payload size manager 745 is capable of, configured to, or operable to support a means for receiving an indication of a threshold payload size associated with the payload size. In some examples, the parameter associated with the UCI includes the payload size and a UCI payload type.

In some examples, the parameter manager 735 is capable of, configured to, or operable to support a means for receiving an indication of the parameter associated with the UCI, where transmitting the UCI to the first cell, to the second cell, or to both the first cell and the second cell is in accordance with the indication of the parameter.

In some examples, the parameter associated with the UCI includes HARQ-ACK feedback associated with the second cell group and the HARQ-ACK feedback is transmitted to both the first cell and the second cell. In some examples, the HARQ-ACK feedback is associated with a subset of HARQ process identifiers in a subset of cells of the second cell group. In some examples, a repetition of the HARQ-ACK feedback is transmitted to both the first cell and the second cell. In some examples, the HARQ-ACK manager 750 is capable of, configured to, or operable to support a means for receiving an indication activating transmitting the HARQ-ACK feedback associated with the second cell group to both the first cell and the second cell. In some examples, the HARQ-ACK manager 750 is capable of, configured to, or operable to support a means for receiving an indication activating transmitting the HARQ-ACK feedback associated with the second cell group to the first cell, to the second cell, or to both the first cell and the second cell.

In some examples, the HARQ-ACK feedback transmitted to the first cell includes a compressed version of the HARQ-ACK feedback and the HARQ-ACK feedback transmitted to the second cell includes a non-compressed version of the HARQ-ACK feedback. In some examples, the compressed version of the HARQ-ACK feedback includes at least one of a bundled ACK/NACK information according to a logical function performed on a set of bits associated with the HARQ-ACK feedback or a set of statistics associated with the ACK/NACK information. In some examples, the compressed version of the HARQ-ACK feedback is transmitted to the first cell in the first cell group or to a different cell in the first cell group.

In some examples, the capability manager 740 is capable of, configured to, or operable to support a means for transmitting a UE capability message indicating support for transmitting the UCI to the first cell, to the second cell, or to both the first cell and the second cell. In some examples, transmitting the UCI to the first cell, to the second cell, or to both the first cell and the second cell is in accordance with a channel quality associated with the second cell.

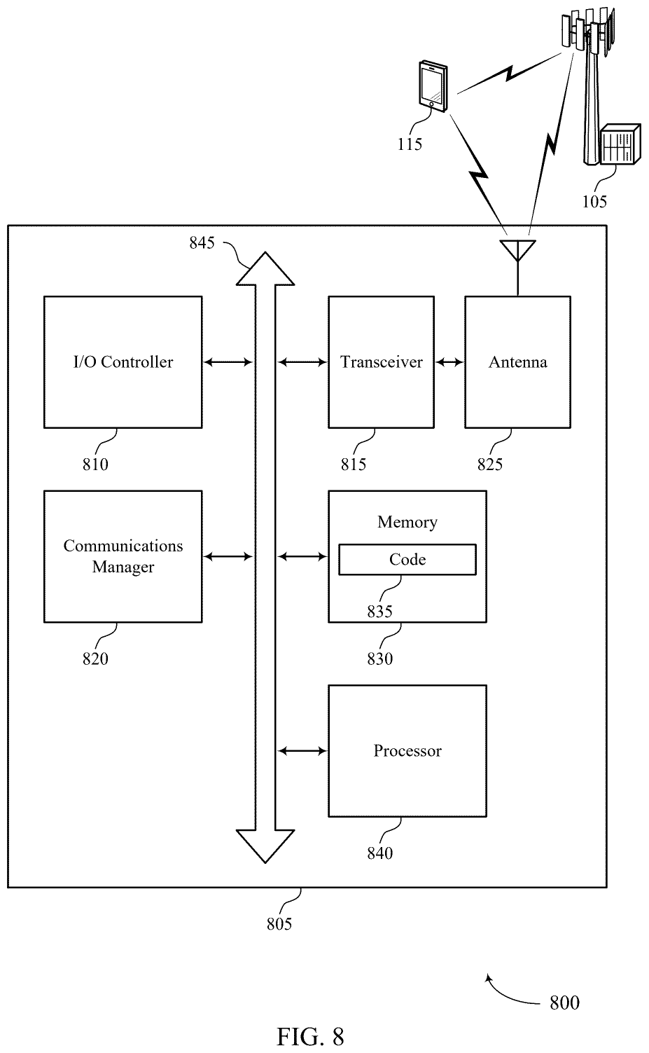

FIG. 8 shows a diagram of a system 800 including a device 805 that supports dual transmission of uplink control in a component carrier group in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting dual transmission of uplink control in a component carrier group). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving signaling indicating a configuration for communications via a first cell group and a second cell group, the first cell group including a first cell used for transmission of UCI associated with the first cell group and the second cell group including a second cell used for transmission of UCI associated with the second cell group. The communications manager 820 is capable of, configured to, or operable to support a means for transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI.

By including or configuring the communications manager 820 in accordance with examples as described herein, the device 805 may support techniques for UCI transmissions in a multi-cell group communication scenario to either the PUCCH cell of a first cell group, to the PUCCH cell of a second cell group, or to both PUCCH cells. The UCI transmissions may be based on a parameter associated with the UCI, which may provide a balanced mechanism to effectively utilize PUCCH resources in both cell groups while maintaining latency and reliability metrics.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of dual transmission of uplink control in a component carrier group as described herein, or the at least one processor 840 and the at least one memory 830 may be otherwise configured to, individually or collectively, perform or support such operations.

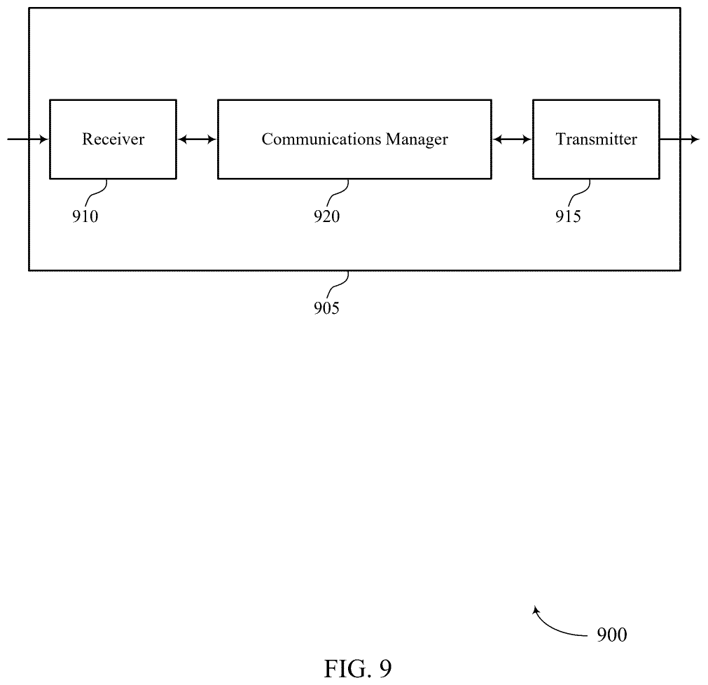

FIG. 9 shows a block diagram 900 of a device 905 that supports dual transmission of uplink control in a component carrier group in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of dual transmission of uplink control in a component carrier group as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The communications manager 920 is capable of, configured to, or operable to support a means for obtaining, from the UE, UCI associated with the second cell group, where receiving the UCI associated with the second cell group from the UE is in accordance with a parameter associated with the UCI. The communications manager 920 is capable of, configured to, or operable to support a means for outputting the UCI associated with the second cell group to the second cell of the second cell group via a backhaul interface between the first cell and the second cell.

Additionally, or alternatively, the communications manager 920 may support wireless communications in accordance with examples as disclosed herein. For example, the communications manager 920 is capable of, configured to, or operable to support a means for obtaining signaling indicating a configuration of a UE for communications via a first cell group and the second cell group, the first cell group including a first cell used for reception of UCI associated with the first cell group and the second cell group including the second cell used for reception of UCI associated with the second cell group. The communications manager 920 is capable of, configured to, or operable to support a means for obtaining, from the UE, UCI associated with the second cell group, where reception of the UCI associated with the second cell group is in accordance with a parameter associated with the UCI. The communications manager 920 is capable of, configured to, or operable to support a means for obtaining the UCI associated with the second cell group from the first cell of the first cell group via a backhaul interface between the first cell and the second cell.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for UCI transmissions in a multi-cell group communication scenario to either the PUCCH cell of a first cell group, to the PUCCH cell of a second cell group, or to both PUCCH cells. The UCI transmissions may be based on a parameter associated with the UCI, which may provide a balanced mechanism to effectively utilize PUCCH resources in both cell groups while maintaining latency and reliability metrics.

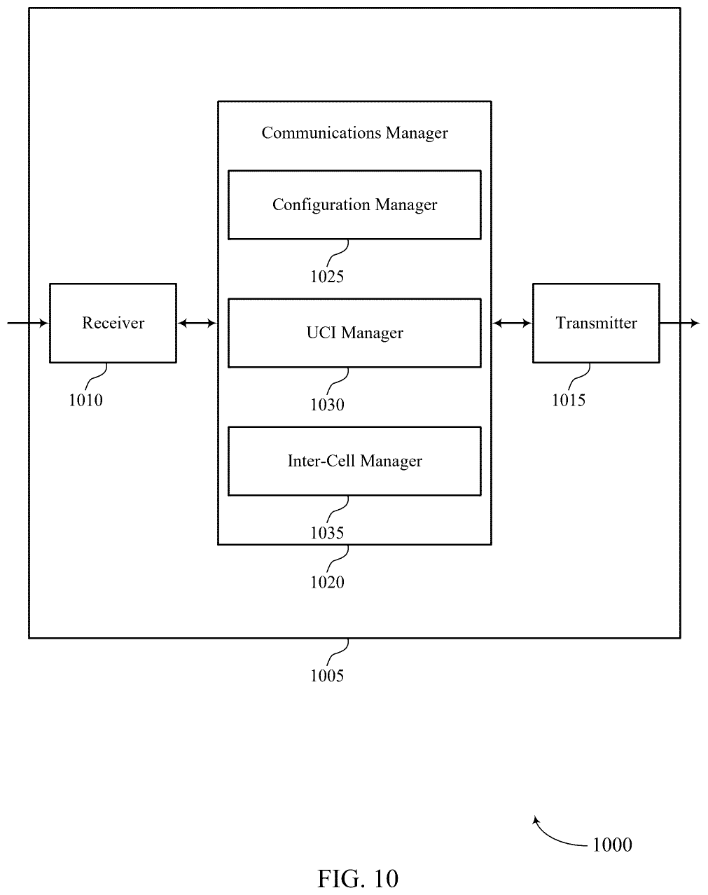

FIG. 10 shows a block diagram 1000 of a device 1005 that supports dual transmission of uplink control in a component carrier group in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of dual transmission of uplink control in a component carrier group as described herein. For example, the communications manager 1020 may include a configuration manager 1025, a UCI manager 1030, an inter-cell manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The UCI manager 1030 is capable of, configured to, or operable to support a means for obtaining, from the UE, UCI associated with the second cell group, where receiving the UCI associated with the second cell group from the UE is in accordance with a parameter associated with the UCI. The inter-cell manager 1035 is capable of, configured to, or operable to support a means for outputting the UCI associated with the second cell group to the second cell of the second cell group via a backhaul interface between the first cell and the second cell.

Additionally, or alternatively, the communications manager 1020 may support wireless communications in accordance with examples as disclosed herein. The configuration manager 1025 is capable of, configured to, or operable to support a means for obtaining signaling indicating a configuration of a UE for communications via a first cell group and the second cell group, the first cell group including a first cell used for reception of UCI associated with the first cell group and the second cell group including the second cell used for reception of UCI associated with the second cell group. The UCI manager 1030 is capable of, configured to, or operable to support a means for obtaining, from the UE, UCI associated with the second cell group, where reception of the UCI associated with the second cell group is in accordance with a parameter associated with the UCI. The inter-cell manager 1035 is capable of, configured to, or operable to support a means for obtaining the UCI associated with the second cell group from the first cell of the first cell group via a backhaul interface between the first cell and the second cell.

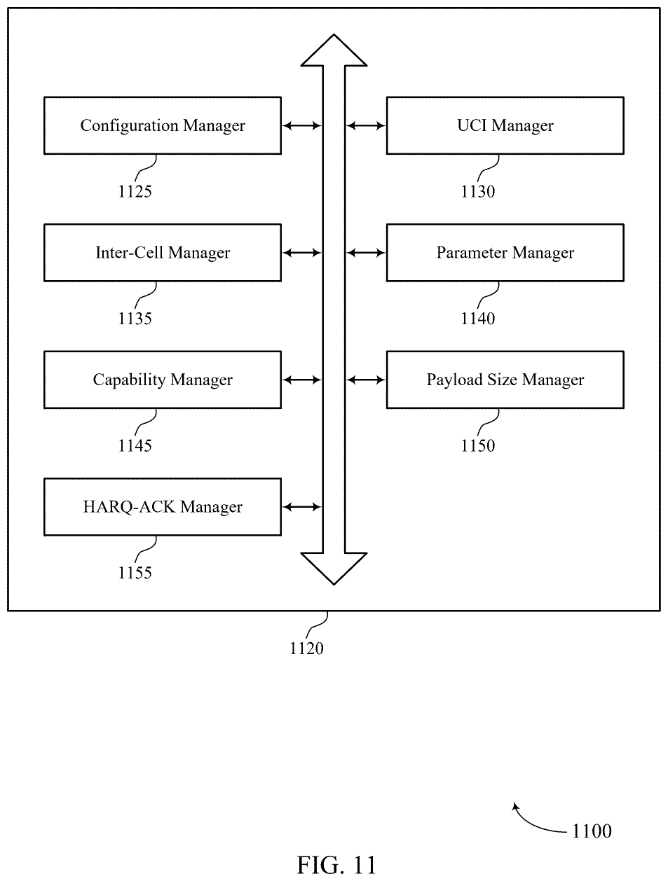

FIG. 11 shows a block diagram 1100 of a communications manager 1120 that supports dual transmission of uplink control in a component carrier group in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of dual transmission of uplink control in a component carrier group as described herein. For example, the communications manager 1120 may include a configuration manager 1125, a UCI manager 1130, an inter-cell manager 1135, a parameter manager 1140, a capability manager 1145, a payload size manager 1150, an HARQ-ACK manager 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The UCI manager 1130 is capable of, configured to, or operable to support a means for obtaining, from the UE, UCI associated with the second cell group, where receiving the UCI associated with the second cell group from the UE is in accordance with a parameter associated with the UCI. The inter-cell manager 1135 is capable of, configured to, or operable to support a means for outputting the UCI associated with the second cell group to the second cell of the second cell group via a backhaul interface between the first cell and the second cell.

In some examples, the parameter associated with the UCI includes a UCI payload type of the UCI. In some examples, the UCI payload type includes CSI feedback and the CSI feedback is obtained by the first cell. In some examples, the parameter associated with the UCI includes a payload size of the UCI, and the UCI is obtained by the first cell in accordance with the payload size of the UCI satisfying a threshold payload size. In some examples, the payload size manager 1150 is capable of, configured to, or operable to support a means for outputting, to the UE, an indication of a threshold payload size associated with the payload size. In some examples, the parameter associated with the UCI includes the payload size and a UCI payload type.

In some examples, the parameter manager 1140 is capable of, configured to, or operable to support a means for outputting, to the UE, an indication of the parameter associated with the UCI, where obtaining the UCI from the UE is in accordance with the indication of the parameter. In some examples, the parameter associated with the UCI includes HARQ-ACK feedback associated with the second cell group and the HARQ-ACK feedback is obtained by both the first cell and the second cell. In some examples, the HARQ-ACK feedback is associated with a subset of HARQ process identifiers in a subset of cells of the second cell group. In some examples, a repetition of the HARQ-ACK feedback is obtained by both the first cell and the second cell. In some examples, the HARQ-ACK manager 1155 is capable of, configured to, or operable to support a means for outputting, to the UE, an indication activating transmission of the HARQ-ACK feedback associated with the second cell group to both the first cell and the second cell. In some examples, the HARQ-ACK manager 1155 is capable of, configured to, or operable to support a means for obtaining an indication activating transmitting the HARQ-ACK feedback associated with the second cell group to the first cell, to the second cell, or to both the first cell and the second cell.

In some examples, the HARQ-ACK feedback obtained by the first cell includes a compressed version of the HARQ-ACK feedback and the HARQ-ACK feedback obtained by the second cell includes a non-compressed version of the HARQ-ACK feedback. In some examples, the compressed version of the HARQ-ACK feedback includes at least one of a bundled ACK/NACK information according to a logical function performed on a set of bits associated with the HARQ-ACK feedback or a set of statistics associated with the ACK/NACK information. In some examples, the compressed version of the HARQ-ACK feedback is obtained by the first cell in the first cell group or to a different cell in the first cell group.

In some examples, the capability manager 1145 is capable of, configured to, or operable to support a means for obtaining a UE capability message indicating support for the UE to transmit the UCI to the first cell, to the second cell, or to both the first cell and the second cell. In some examples, the UE transmitting the UCI to the first cell, to the second cell, or to both the first cell and the second cell is in accordance with a channel quality associated with the second cell.

Additionally, or alternatively, the communications manager 1120 may support wireless communications in accordance with examples as disclosed herein. In some examples, the configuration manager 1125 is capable of, configured to, or operable to support a means for obtaining signaling indicating a configuration of a UE for communications via a first cell group and the second cell group, the first cell group including a first cell used for reception of UCI associated with the first cell group and the second cell group including the second cell used for reception of UCI associated with the second cell group. In some examples, the UCI manager 1130 is capable of, configured to, or operable to support a means for obtaining, from the UE, UCI associated with the second cell group, where reception of the UCI associated with the second cell group is in accordance with a parameter associated with the UCI. In some examples, the inter-cell manager 1135 is capable of, configured to, or operable to support a means for obtaining the UCI associated with the second cell group from the first cell of the first cell group via a backhaul interface between the first cell and the second cell.

In some examples, the parameter associated with the UCI includes a UCI payload type of the UCI. In some examples, the UCI payload type includes HARQ-ACK feedback and the HARQ-ACK feedback is obtained by the second cell. In some examples, the UCI payload type includes a SR and the SR is obtained by the second cell. In some examples, the parameter associated with the UCI includes a payload size of the UCI. In some examples, the UCI is obtained by the second cell in accordance with the payload size of the UCI failing to satisfy a threshold payload size. In some examples, the parameter associated with the UCI includes the payload size and a UCI payload type. In some examples, the parameter associated with the UCI includes HARQ-ACK feedback associated with the second cell group and the HARQ-ACK feedback is obtained by both the first cell and the second cell.

In some examples, the HARQ-ACK feedback is associated with a subset of HARQ process identifiers in a subset of cells of the second cell group. In some examples, a repetition of the HARQ-ACK feedback is obtained by both the first cell and the second cell. In some examples, the HARQ-ACK feedback obtained by the first cell includes a compressed version of the HARQ-ACK feedback and the HARQ-ACK feedback obtained by the second cell includes a non-compressed version of the HARQ-ACK feedback.

In some examples, the HARQ-ACK manager 1155 is capable of, configured to, or operable to support a means for adjusting one or more communication parameters for communicating with the UE in accordance with the UCI obtained from the first cell. In some examples, the UE transmitting the UCI to the first cell, to the second cell, or to both the first cell and the second cell is in accordance with a channel quality associated with the second cell.

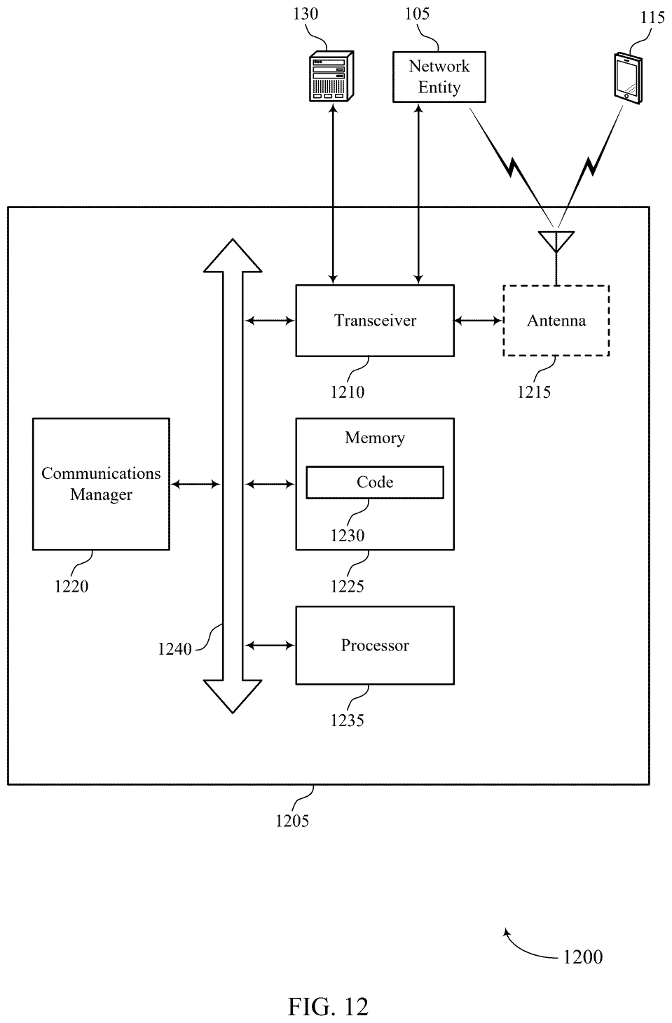

FIG. 12 shows a diagram of a system 1200 including a device 1205 that supports dual transmission of uplink control in a component carrier group in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting dual transmission of uplink control in a component carrier group). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The communications manager 1220 is capable of, configured to, or operable to support a means for obtaining, from the UE, UCI associated with the second cell group, where receiving the UCI associated with the second cell group from the UE is in accordance with a parameter associated with the UCI. The communications manager 1220 is capable of, configured to, or operable to support a means for outputting the UCI associated with the second cell group to the second cell of the second cell group via a backhaul interface between the first cell and the second cell.

Additionally, or alternatively, the communications manager 1220 may support wireless communications in accordance with examples as disclosed herein. For example, the communications manager 1220 is capable of, configured to, or operable to support a means for obtaining signaling indicating a configuration of a UE for communications via a first cell group and the second cell group, the first cell group including a first cell used for reception of UCI associated with the first cell group and the second cell group including the second cell used for reception of UCI associated with the second cell group. The communications manager 1220 is capable of, configured to, or operable to support a means for obtaining, from the UE, UCI associated with the second cell group, where reception of the UCI associated with the second cell group is in accordance with a parameter associated with the UCI. The communications manager 1220 is capable of, configured to, or operable to support a means for obtaining the UCI associated with the second cell group from the first cell of the first cell group via a backhaul interface between the first cell and the second cell.

By including or configuring the communications manager 1220 in accordance with examples as described herein, the device 1205 may support techniques for UCI transmissions in a multi-cell group communication scenario to either the PUCCH cell of a first cell group, to the PUCCH cell of a second cell group, or to both PUCCH cells. The UCI transmissions may be based on a parameter associated with the UCI, which may provide a balanced mechanism to effectively utilize PUCCH resources in both cell groups while maintaining latency and reliability metrics.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of dual transmission of uplink control in a component carrier group as described herein, or the at least one processor 1235 and the at least one memory 1225 may be otherwise configured to, individually or collectively, perform or support such operations.

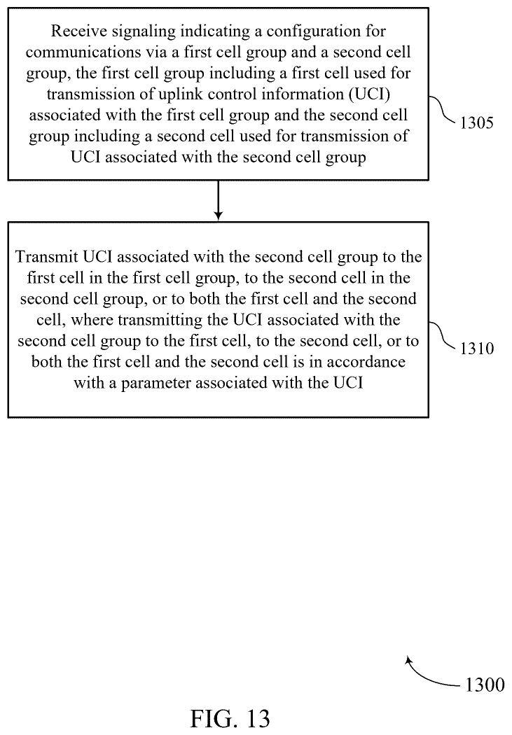

FIG. 13 shows a flowchart illustrating a method 1300 that supports dual transmission of uplink control in a component carrier group in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving signaling indicating a configuration for communications via a first cell group and a second cell group, the first cell group including a first cell used for transmission of UCI associated with the first cell group and the second cell group including a second cell used for transmission of UCI associated with the second cell group. The operations of 1305 may be performed in accordance with examples as disclosed herein. In some examples, aspects of the operations of 1305 may be performed by a configuration manager 725 as described with reference to FIG. 7.

At 1310, the method may include transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI. The operations of 1310 may be performed in accordance with examples as disclosed herein. In some examples, aspects of the operations of 1310 may be performed by a UCI manager 730 as described with reference to FIG. 7.

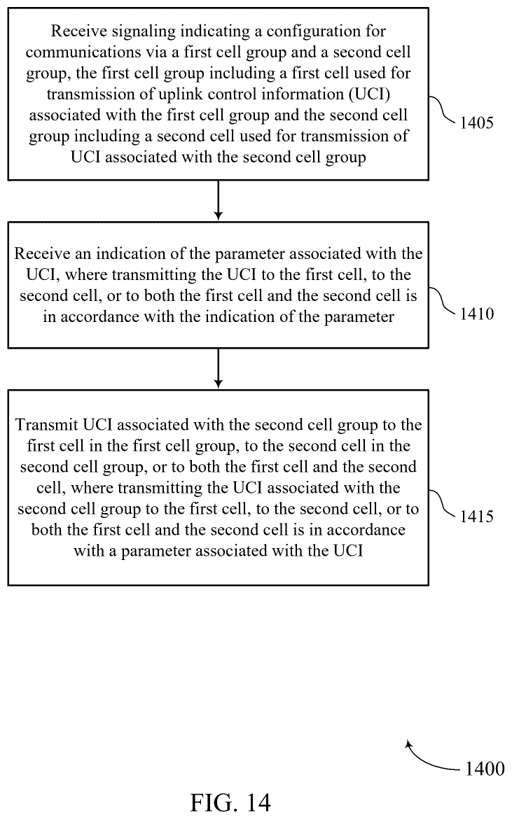

FIG. 14 shows a flowchart illustrating a method 1400 that supports dual transmission of uplink control in a component carrier group in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving signaling indicating a configuration for communications via a first cell group and a second cell group, the first cell group including a first cell used for transmission of UCI associated with the first cell group and the second cell group including a second cell used for transmission of UCI associated with the second cell group. The operations of 1405 may be performed in accordance with examples as disclosed herein. In some examples, aspects of the operations of 1405 may be performed by a configuration manager 725 as described with reference to FIG. 7.

At 1410, the method may include receiving an indication of the parameter associated with the UCI, where transmitting the UCI to the first cell, to the second cell, or to both the first cell and the second cell is in accordance with the indication of the parameter. The operations of 1410 may be performed in accordance with examples as disclosed herein. In some examples, aspects of the operations of 1410 may be performed by a parameter manager 735 as described with reference to FIG. 7.

At 1415, the method may include transmitting UCI associated with the second cell group to the first cell in the first cell group, to the second cell in the second cell group, or to both the first cell and the second cell, where transmitting the UCI associated with the second cell group to the first cell, to the second cell, or to both the first cell and the second cell is in accordance with a parameter associated with the UCI. The operations of 1415 may be performed in accordance with examples as disclosed herein. In some examples, aspects of the operations of 1415 may be performed by a UCI manager 730 as described with reference to FIG. 7.

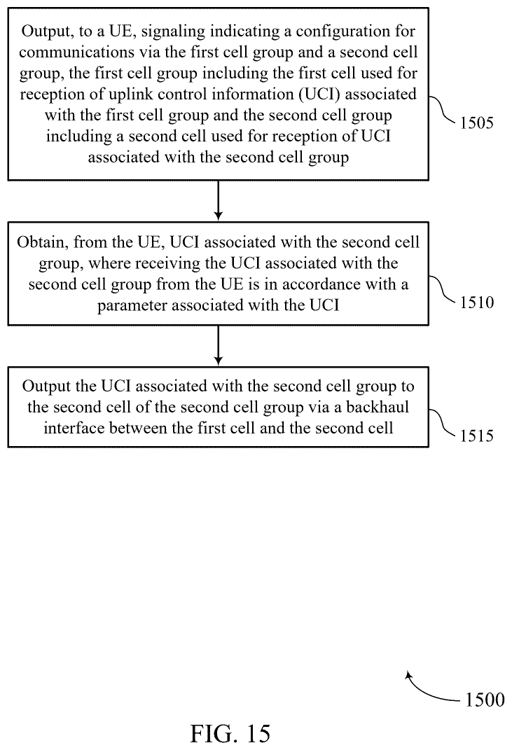

FIG. 15 shows a flowchart illustrating a method 1500 that supports dual transmission of uplink control in a component carrier group in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The operations of 1505 may be performed in accordance with examples as disclosed herein. In some examples, aspects of the operations of 1505 may be performed by a configuration manager 1125 as described with reference to FIG. 11.

At 1510, the method may include obtaining, from the UE, UCI associated with the second cell group, where receiving the UCI associated with the second cell group from the UE is in accordance with a parameter associated with the UCI. The operations of 1510 may be performed in accordance with examples as disclosed herein. In some examples, aspects of the operations of 1510 may be performed by a UCI manager 1130 as described with reference to FIG. 11.

At 1515, the method may include outputting the UCI associated with the second cell group to the second cell of the second cell group via a backhaul interface between the first cell and the second cell. The operations of 1515 may be performed in accordance with examples as disclosed herein. In some examples, aspects of the operations of 1515 may be performed by an inter-cell manager 1135 as described with reference to FIG. 11.

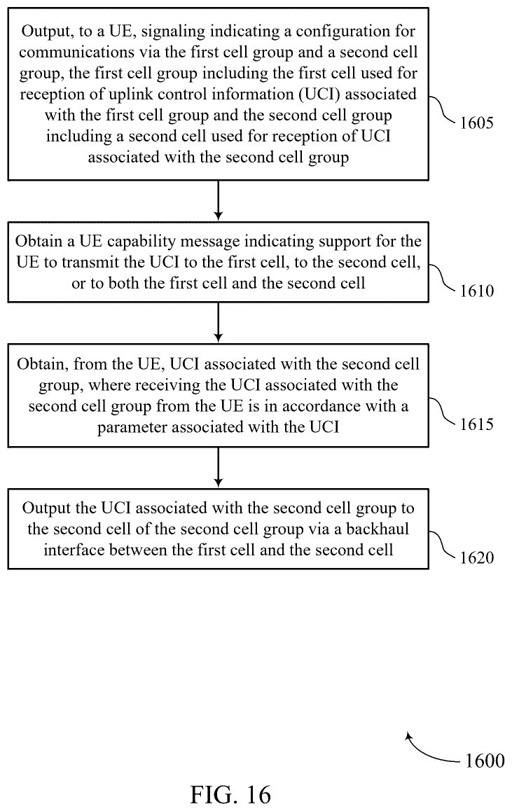

FIG. 16 shows a flowchart illustrating a method 1600 that supports dual transmission of uplink control in a component carrier group in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a UE, signaling indicating a configuration for communications via the first cell group and a second cell group, the first cell group including the first cell used for reception of UCI associated with the first cell group and the second cell group including a second cell used for reception of UCI associated with the second cell group. The operations of 1605 may be performed in accordance with examples as disclosed herein. In some examples, aspects of the operations of 1605 may be performed by a configuration manager 1125 as described with reference to FIG. 11.

At 1610, the method may include obtaining a UE capability message indicating support for the UE to transmit the UCI to the first cell, to the second cell, or to both the first cell and the second cell. The operations of 1610 may be performed in accordance with examples as disclosed herein. In some examples, aspects of the operations of 1610 may be performed by a capability manager 1145 as described with reference to FIG. 11.

At 1615, the method may include obtaining, from the UE, UCI associated with the second cell group, where receiving the UCI associated with the second cell group from the UE is in accordance with a parameter associated with the UCI. The operations of 1615 may be performed in accordance with examples as disclosed herein. In some examples, aspects of the operations of 1615 may be performed by a UCI manager 1130 as described with reference to FIG. 11.

At 1620, the method may include outputting the UCI associated with the second cell group to the second cell of the second cell group via a backhaul interface between the first cell and the second cell. The operations of 1620 may be performed in accordance with examples as disclosed herein. In some examples, aspects of the operations of 1620 may be performed by an inter-cell manager 1135 as described with reference to FIG. 11.

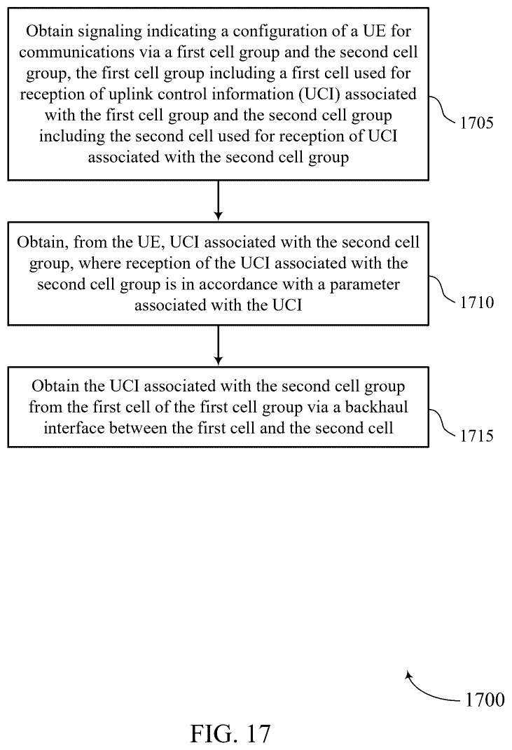

FIG. 17 shows a flowchart illustrating a method 1700 that supports dual transmission of uplink control in a component carrier group in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include obtaining signaling indicating a configuration of a UE for communications via a first cell group and the second cell group, the first cell group including a first cell used for reception of UCI associated with the first cell group and the second cell group including the second cell used for reception of UCI associated with the second cell group. The operations of 1705 may be performed in accordance with examples as disclosed herein. In some examples, aspects of the operations of 1705 may be performed by a configuration manager 1125 as described with reference to FIG. 11.

At 1710, the method may include obtaining, from the UE, UCI associated with the second cell group, where reception of the UCI associated with the second cell group is in accordance with a parameter associated with the UCI. The operations of 1710 may be performed in accordance with examples as disclosed herein. In some examples, aspects of the operations of 1710 may be performed by a UCI manager 1130 as described with reference to FIG. 11.

At 1715, the method may include obtaining the UCI associated with the second cell group from the first cell of the first cell group via a backhaul interface between the first cell and the second cell. The operations of 1715 may be performed in accordance with examples as disclosed herein. In some examples, aspects of the operations of 1715 may be performed by an inter-cell manager 1135 as described with reference to FIG. 11.

The following provides an overview of aspects of the present disclosure:

Aspect 1: A method for wireless communications at a UE, comprising: receiving signaling indicating a configuration for communications via a first cell group and a second cell group, the first cell group comprising a first cell used for transmission of UCI associated with the first cell group and the second cell group comprising a second cell used for transmission of UCI associated with the second cell group; and transmitting UCI associated with the second cell group to the first cell in the first cell group, to the second cell in the second cell group, or to both the first cell and the second cell, wherein transmitting the UCI associated with the second cell group to the first cell, to the second cell, or to both the first cell and the second cell is in accordance with a parameter associated with the UCI.

Aspect 2: The method of aspect 1, wherein the parameter associated with the UCI comprises a UCI payload type of the UCI.

Aspect 3: The method of aspect 2, wherein the UCI payload type comprises HARQ-ACK feedback and the HARQ-ACK feedback is transmitted to the second cell.

Aspect 4: The method of any of aspects 2 through 3, wherein the UCI payload type comprises CSI feedback and the CSI feedback is transmitted to the first cell.

Aspect 5: The method of any of aspects 2 through 4, wherein the UCI payload type comprises a SR and the SR is transmitted to the second cell.

Aspect 6: The method of any of aspects 1 through 5, wherein the parameter associated with the UCI comprises a payload size of the UCI, the UCI is transmitted to the second cell in accordance with the payload size of the UCI failing to satisfy a threshold payload size, and the UCI is transmitted to the first cell in accordance with the payload size of the UCI satisfying the threshold payload size.

Aspect 7: The method of aspect 6, further comprising: receiving an indication of a threshold payload size associated with the payload size.

Aspect 8: The method of any of aspects 6 through 7, wherein the parameter associated with the UCI comprises the payload size and a UCI payload type.

Aspect 9: The method of any of aspects 1 through 8, further comprising: receiving an indication of the parameter associated with the UCI, wherein transmitting the UCI to the first cell, to the second cell, or to both the first cell and the second cell is in accordance with the indication of the parameter.

Aspect 10: The method of any of aspects 1 through 9, wherein the parameter associated with the UCI comprises HARQ-ACK feedback associated with the second cell group and the HARQ-ACK feedback is transmitted to both the first cell and the second cell.

Aspect 11: The method of aspect 10, wherein the HARQ-ACK feedback is associated with a subset of HARQ process identifiers in a subset of cells of the second cell group.

Aspect 12: The method of any of aspects 10 through 11, wherein a repetition of the HARQ-ACK feedback is transmitted to both the first cell and the second cell.

Aspect 13: The method of any of aspects 10 through 12, further comprising: receiving an indication activating transmitting the HARQ-ACK feedback associated with the second cell group to both the first cell and the second cell.

Aspect 14: The method of any of aspects 10 through 13, further comprising: receiving an indication activating transmitting the HARQ-ACK feedback associated with the second cell group to the first cell, to the second cell, or to both the first cell and the second cell.

Aspect 15: The method of any of aspects 10 through 14, wherein the HARQ-ACK feedback transmitted to the first cell comprises a compressed version of the HARQ-ACK feedback and the HARQ-ACK feedback transmitted to the second cell comprises a non-compressed version of the HARQ-ACK feedback.

Aspect 16: The method of aspect 15, wherein the compressed version of the HARQ-ACK feedback comprises at least one of a bundled ACK/NACK information according to a logical function performed on a set of bits associated with the HARQ-ACK feedback or a set of statistics associated with the ACK/NACK information.

Aspect 17: The method of any of aspects 15 through 16, wherein the compressed version of the HARQ-ACK feedback is transmitted to the first cell in the first cell group or to a different cell in the first cell group.

Aspect 18: The method of any of aspects 1 through 17, further comprising: transmitting a UE capability message indicating support for transmitting the UCI to the first cell, to the second cell, or to both the first cell and the second cell.

Aspect 19: The method of any of aspects 1 through 18, wherein transmitting the UCI to the first cell, to the second cell, or to both the first cell and the second cell is in accordance with a channel quality associated with the second cell.

Aspect 20: A method for wireless communications at a first cell in a first cell group, comprising: outputting, to a UE, signaling indicating a configuration for communications via the first cell group and a second cell group, the first cell group comprising the first cell used for reception of UCI associated with the first cell group and the second cell group comprising a second cell used for reception of UCI associated with the second cell group; obtaining, from the UE, UCI associated with the second cell group, wherein receiving the UCI associated with the second cell group from the UE is in accordance with a parameter associated with the UCI; and outputting the UCI associated with the second cell group to the second cell of the second cell group via a backhaul interface between the first cell and the second cell.

Aspect 21: The method of aspect 20, wherein the parameter associated with the UCI comprises a UCI payload type of the UCI.

Aspect 22: The method of aspect 21, wherein the UCI payload type comprises CSI feedback and the CSI feedback is obtained by the first cell.

Aspect 23: The method of any of aspects 20 through 22, wherein the parameter associated with the UCI comprises a payload size of the UCI, and the UCI is obtained by the first cell in accordance with the payload size of the UCI satisfying a threshold payload size.

Aspect 24: The method of aspect 23, further comprising: outputting, to the UE, an indication of a threshold payload size associated with the payload size.

Aspect 25: The method of any of aspects 23 through 24, wherein the parameter associated with the UCI comprises the payload size and a UCI payload type.

Aspect 26: The method of any of aspects 20 through 25, further comprising: outputting, to the UE, an indication of the parameter associated with the UCI, wherein obtaining the UCI from the UE is in accordance with the indication of the parameter.

Aspect 27: The method of any of aspects 20 through 26, wherein the parameter associated with the UCI comprises HARQ-ACK feedback associated with the second cell group and the HARQ-ACK feedback is obtained by both the first cell and the second cell.

Aspect 28: The method of aspect 27, wherein the HARQ-ACK feedback is associate with a subset of HARQ process identifiers in a subset of cells of the second cell group.

Aspect 29: The method of any of aspects 27 through 28, wherein a repetition of the HARQ-ACK feedback is obtained by both the first cell and the second cell.

Aspect 30: The method of any of aspects 27 through 29, further comprising: outputting, to the UE, an indication activating transmission of the HARQ-ACK feedback associated with the second cell group to both the first cell and the second cell.

Aspect 31: The method of any of aspects 27 through 30, further comprising: obtaining an indication activating transmitting the HARQ-ACK feedback associated with the second cell group to the first cell, to the second cell, or to both the first cell and the second cell.

Aspect 32: The method of any of aspects 27 through 31, wherein the HARQ-ACK feedback obtained by the first cell comprises a compressed version of the HARQ-ACK feedback and the HARQ-ACK feedback obtained by the second cell comprises a non-compressed version of the HARQ-ACK feedback.

Aspect 33: The method of aspect 32, wherein the compressed version of the HARQ-ACK feedback comprises at least one of a bundled ACK/NACK information according to a logical function performed on a set of bits associated with the HARQ-ACK feedback or a set of statistics associated with the ACK/NACK information.

Aspect 34: The method of any of aspects 32 through 33, wherein the compressed version of the HARQ-ACK feedback is obtained by the first cell in the first cell group or to a different cell in the first cell group.

Aspect 35: The method of any of aspects 20 through 34, further comprising: obtaining a UE capability message indicating support for the UE to transmit the UCI to the first cell, to the second cell, or to both the first cell and the second cell.

Aspect 36: The method of any of aspects 20 through 35, wherein the UE transmitting the UCI to the first cell, to the second cell, or to both the first cell and the second cell is in accordance with a channel quality associated with the second cell.

Aspect 37: A method for wireless communications at a second cell of a second cell group, comprising: obtaining signaling indicating a configuration of a UE for communications via a first cell group and the second cell group, the first cell group comprising a first cell used for reception of UCI associated with the first cell group and the second cell group comprising the second cell used for reception of UCI associated with the second cell group; obtaining, from the UE, UCI associated with the second cell group, wherein reception of the UCI associated with the second cell group is in accordance with a parameter associated with the UCI; and obtaining the UCI associated with the second cell group from the first cell of the first cell group via a backhaul interface between the first cell and the second cell.

Aspect 38: The method of aspect 37, wherein the parameter associated with the UCI comprises a UCI payload type of the UCI.

Aspect 39: The method of aspect 38, wherein the UCI payload type comprises HARQ-ACK feedback and the HARQ-ACK feedback is obtained by the second cell.

Aspect 40: The method of any of aspects 38 through 39, wherein the UCI payload type comprises a SR and the SR is obtained by the second cell.

Aspect 41: The method of any of aspects 37 through 40, wherein the parameter associated with the UCI comprises a payload size of the UCI.

Aspect 42: The method of aspect 41, wherein the UCI is obtained by the second cell in accordance with the payload size of the UCI failing to satisfy a threshold payload size.

Aspect 43: The method of any of aspects 41 through 42, wherein the parameter associated with the UCI comprises the payload size and a UCI payload type.

Aspect 44: The method of any of aspects 37 through 43, wherein the parameter associated with the UCI comprises HARQ-ACK feedback associated with the second cell group and the HARQ-ACK feedback is obtained by both the first cell and the second cell.

Aspect 45: The method of aspect 44, wherein the HARQ-ACK feedback is associated with a subset of HARQ process identifiers in a subset of cells of the second cell group.

Aspect 46: The method of any of aspects 44 through 45, wherein a repetition of the HARQ-ACK feedback is obtained by both the first cell and the second cell.

Aspect 47: The method of any of aspects 44 through 46, wherein the HARQ-ACK feedback obtained by the first cell comprises a compressed version of the HARQ-ACK feedback and the HARQ-ACK feedback obtained by the second cell comprises a non-compressed version of the HARQ-ACK feedback.

Aspect 48: The method of any of aspects 44 through 47, further comprising: adjusting one or more communication parameters for communicating with the UE in accordance with the UCI obtained from the first cell.

Aspect 49: The method of any of aspects 37 through 48, wherein the UE transmitting the UCI to the first cell, to the second cell, or to both the first cell and the second cell is in accordance with a channel quality associated with the second cell.

Aspect 50: A UE for wireless communications, comprising one or more memories storing processor-executable code, and one or more processors coupled with the one or more memories and individually or collectively operable to execute the code to cause the UE to perform a method of any of aspects 1 through 19.

Aspect 51: A UE for wireless communications, comprising at least one means for performing a method of any of aspects 1 through 19.

Aspect 52: A non-transitory computer-readable medium storing code for wireless communications, the code comprising instructions executable by one or more processors to perform a method of any of aspects 1 through 19.

Aspect 53: A wireless device associated with a first cell in a first cell group for wireless communications, comprising one or more memories storing processor-executable code, and one or more processors coupled with the one or more memories and individually or collectively operable to execute the code to cause the first cell in a first cell group to perform a method of any of aspects 20 through 36.

Aspect 54: A first cell in a first cell group for wireless communications, comprising at least one means for performing a method of any of aspects 20 through 36.

Aspect 55: A non-transitory computer-readable medium storing code for wireless communications, the code comprising instructions executable by one or more processors to perform a method of any of aspects 20 through 36.

Aspect 56: A wireless device associated with a second cell of a second cell group for wireless communications, comprising one or more memories storing processor-executable code, and one or more processors coupled with the one or more memories and individually or collectively operable to execute the code to cause the second cell of a second cell group to perform a method of any of aspects 37 through 49.

Aspect 57: A second cell of a second cell group for wireless communications, comprising at least one means for performing a method of any of aspects 37 through 49.

Aspect 58: A non-transitory computer-readable medium storing code for wireless communications, the code comprising instructions executable by one or more processors to perform a method of any of aspects 37 through 49.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive signaling indicating a configuration for communications via a first cell group and a second cell group, the first cell group comprising a first cell used for transmission of uplink control information (UCI) associated with the first cell group and the second cell group comprising a second cell used for transmission of UCI associated with the second cell group; and
transmit UCI associated with the second cell group to the first cell in the first cell group, to the second cell in the second cell group, or to both the first cell and the second cell, wherein transmitting the UCI associated with the second cell group to the first cell, to the second cell, or to both the first cell and the second cell is in accordance with a parameter associated with the UCI.

2. The UE of claim 1, wherein the parameter associated with the UCI comprises a UCI payload type of the UCI.

3. The UE of claim 2, wherein the UCI payload type comprises hybrid automatic repeat/request acknowledgment (HARQ-ACK) feedback and the HARQ-ACK feedback is transmitted to the second cell.

4. The UE of claim 2, wherein the UCI payload type comprises channel state information (CSI) feedback and the CSI feedback is transmitted to the first cell.

5. The UE of claim 2, wherein the UCI payload type comprises a scheduling request (SR) and the SR is transmitted to the second cell.

6. The UE of claim 1, wherein the parameter associated with the UCI comprises a payload size of the UCI, the UCI is transmitted to the second cell in accordance with the payload size of the UCI failing to satisfy a threshold payload size, and the UCI is transmitted to the first cell in accordance with the payload size of the UCI satisfying the threshold payload size.

7. The UE of claim 6, wherein the one or more processors are individually or collectively further operable to execute the code to cause the UE to:
receive an indication of a threshold payload size associated with the payload size.

8. The UE of claim 6, wherein the parameter associated with the UCI comprises the payload size and a UCI payload type.

9. The UE of claim 1, wherein the one or more processors are individually or collectively further operable to execute the code to cause the UE to:
receive an indication of the parameter associated with the UCI, wherein transmitting the UCI to the first cell, to the second cell, or to both the first cell and the second cell is in accordance with the indication of the parameter.

10. The UE of claim 1, wherein the parameter associated with the UCI comprises hybrid automatic repeat/request acknowledgment (HARQ-ACK) feedback associated with the second cell group and the HARQ-ACK feedback is transmitted to both the first cell and the second cell.

11. The UE of claim 10, wherein the HARQ-ACK feedback is associated with a subset of HARQ process identifiers in a subset of cells of the second cell group.

12. The UE of claim 10, wherein a repetition of the HARQ-ACK feedback is transmitted to both the first cell and the second cell.

13. The UE of claim 10, wherein the one or more processors are individually or collectively further operable to execute the code to cause the UE to:
receive an indication activating transmitting the HARQ-ACK feedback associated with the second cell group to both the first cell and the second cell.

14. The UE of claim 10, wherein the one or more processors are individually or collectively further operable to execute the code to cause the UE to:
receive an indication activating transmitting the HARQ-ACK feedback associated with the second cell group to the first cell, to the second cell, or to both the first cell and the second cell.

15. The UE of claim 10, wherein the HARQ-ACK feedback transmitted to the first cell comprises a compressed version of the HARQ-ACK feedback and the HARQ-ACK feedback transmitted to the second cell comprises a non-compressed version of the HARQ-ACK feedback.

16. The UE of claim 15, wherein the compressed version of the HARQ-ACK feedback comprises at least one of a bundled acknowledgement/negative-acknowledgement (ACK/NACK) information according to a logical function performed on a set of bits associated with the HARQ-ACK feedback or a set of statistics associated with the ACK/NACK information.

17. The UE of claim 15, wherein the compressed version of the HARQ-ACK feedback is transmitted to the first cell in the first cell group or to a different cell in the first cell group.

18. The UE of claim 1, wherein the one or more processors are individually or collectively further operable to execute the code to cause the UE to:
transmit a UE capability message indicating support for transmitting the UCI to the first cell, to the second cell, or to both the first cell and the second cell.

19. The UE of claim 1, wherein transmitting the UCI to the first cell, to the second cell, or to both the first cell and the second cell is in accordance with a channel quality associated with the second cell.

20. A wireless device associated with a first cell in a first cell group, comprising:
one or more memories storing processor-executable code; and
one or more processors coupled with the one or more memories and individually or collectively operable to execute the code to cause the first cell in a first cell group to:
output, to a user equipment (UE), signaling indicating a configuration for communications via the first cell group and a second cell group, the first cell group comprising the first cell used for reception of uplink control information (UCI) associated with the first cell group and the second cell group comprising a second cell used for reception of UCI associated with the second cell group;
obtain, from the UE, UCI associated with the second cell group, wherein receiving the UCI associated with the second cell group from the UE is in accordance with a parameter associated with the UCI; and
output the UCI associated with the second cell group to the second cell of the second cell group via a backhaul interface between the first cell and the second cell.

21. A method for wireless communications at a user equipment (UE), comprising:
receiving signaling indicating a configuration for communications via a first cell group and a second cell group, the first cell group comprising a first cell used for transmission of uplink control information (UCI) associated with the first cell group and the second cell group comprising a second cell used for transmission of UCI associated with the second cell group; and
transmitting UCI associated with the second cell group to the first cell in the first cell group, to the second cell in the second cell group, or to both the first cell and the second cell, wherein transmitting the UCI associated with the second cell group to the first cell, to the second cell, or to both the first cell and the second cell is in accordance with a parameter associated with the UCI.

22. The method of claim 21, wherein the parameter associated with the UCI comprises a UCI payload type of the UCI.

23. The method of claim 22, wherein the UCI payload type comprises hybrid automatic repeat/request acknowledgment (HARQ-ACK) feedback and the HARQ-ACK feedback is transmitted to the second cell.

24. The method of claim 22, wherein the UCI payload type comprises channel state information (CSI) feedback and the CSI feedback is transmitted to the first cell.

25. The method of claim 22, wherein the UCI payload type comprises a scheduling request (SR) and the SR is transmitted to the second cell.

26. The method of claim 21, wherein the parameter associated with the UCI comprises a payload size of the UCI, the UCI is transmitted to the second cell in accordance with the payload size of the UCI failing to satisfy a threshold payload size, and the UCI is transmitted to the first cell in accordance with the payload size of the UCI satisfying the threshold payload size.

27. The method of claim 26, further comprising:
receiving an indication of a threshold payload size associated with the payload size.

28. The method of claim 26, wherein the parameter associated with the UCI comprises the payload size and a UCI payload type.

29. The method of claim 21, further comprising:
receiving an indication of the parameter associated with the UCI, wherein transmitting the UCI to the first cell, to the second cell, or to both the first cell and the second cell is in accordance with the indication of the parameter.

30. A method for wireless communications at a first cell in a first cell group, comprising:
outputting, to a user equipment (UE), signaling indicating a configuration for communications via the first cell group and a second cell group, the first cell group comprising the first cell used for reception of uplink control information (UCI) associated with the first cell group and the second cell group comprising a second cell used for reception of UCI associated with the second cell group;
obtaining, from the UE, UCI associated with the second cell group, wherein receiving the UCI associated with the second cell group from the UE is in accordance with a parameter associated with the UCI; and
outputting the UCI associated with the second cell group to the second cell of the second cell group via a backhaul interface between the first cell and the second cell.
